(19) United States
(12) Patent Application Publication
(10) Pub. No.: US 2026/0270791 A1
(43) Pub. Date: Sep. 10, 2026

(54) TERMINAL, BASE STATION, AND COMMUNICATION METHOD

(71) Applicant: Panasonic Intellectual Property Corporation of America, Torrance, CA (US)

(72) Inventors: Tetsuya YAMAMOTO, Kanagawa (JP); Hidetoshi SUZUKI, Kanagawa (JP)

(73) Assignee: Panasonic Intellectual Property Corporation of America, Torrance, CA (US)

(21) Appl. No.: 19/164,858

(22) PCT Filed: Apr. 3, 2023
(86) PCT No.: PCT/JP2023/013818

§ 371 Date: Sep. 12, 2025

(51) Int. Cl. H04W 28/18; H04L 1/00; H04L 5/00

(52) U.S. Cl. CPC H04W 28/18; H04L 5/0098; H04L 1/0003

(57) ABSTRACT

This terminal includes: a control circuit that sets the transmission waveform for a second signal on the basis of a condition related to repeated transmission of a first signal; and a transmission circuit that transmits the second signal using the transmission waveform.

### TECHNICAL FIELD

The present disclosure relates to a terminal, a base station, and a communication method.

### BACKGROUND ART

In recent years, a dramatic growth of Internet of Things (IoT) has been expected with the expansion and diversification of radio services as a background. The usage of mobile communication is expanding to all fields such as automobiles, houses, home electric appliances, or industrial equipment in addition to information terminals such as smartphones. In order to support the diversification of services, a substantial improvement in the performance and function of mobile communication systems has been required for various requirements such as an increase in the number of connected devices or low latency in addition to an increase in system capacity. The 5th generation mobile communication system (5G) has features such as enhanced mobile broadband (eMBB), massive machine type communication (mMTC), and ultra reliable and low latency communication (URLLC), and flexibly provides radio communication in response to a wide variety of needs.

The 3rd Generation Partnership Project (3GPP) as an international standardizing body has been specifying New Radio (NR) as one of 5G radio interfaces.

### CITATION LIST

Non-Patent Literature (hereinafter, referred to as “NPL”)

### NPL 1

3GPP TS38.104 V15.18.0, “NR Base Station (BS) radio transmission and reception (Release 15),” September 2022.

### NPL 2

RP-202928, “New WID on NR coverage enhancements,” China Telecom, December 2020.

### NPL 3

RP-220937, “Revised WID on Further NR coverage enhancements,” China Telecom, March 2022.

### NPL 4

3GPP TS38.211 V17.5.0, “NR Physical channels and modulation (Release 17),” March 2023.

### NPL 5

3GPP TS38.212 V17.5.0, “NR Multiplexing and channel coding (Release 17),” March 2023.

### NPL 6

3GPP TS38.213 V17.5.0, “NR Physical layer procedures for control (Release 17),” March 2023.

### NPL 7

3GPP TS38.214 V17.5.0, “NR Physical layer procedures for data (Release 17),” March 2023.

### SUMMARY OF INVENTION

There is, however, room for consideration on a method for transmitting a signal in the uplink.

One non-limiting and exemplary embodiment facilitates providing a terminal, a base station, and a communication method each capable of improving the reception performance of a signal in uplink.

### Solution to Problem

A terminal according to an embodiment of the present disclosure includes: control circuitry, which, in operation, configures, based on a condition related to repetition transmission of a first signal, a transmission waveform of a second signal; and transmission circuitry, which, in operation, transmits the second signal using the transmission waveform.

It should be noted that general or specific embodiments may be implemented as a system, a method, an integrated circuit, a computer program, a storage medium, or any selective combination thereof.

According to an embodiment of the present disclosure, a signal can be appropriately transmitted in uplink.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an exemplary requirement condition for Message 3 (Msg.3) Physical Uplink Shared Channel (PUSCH) repetition and exemplary Modulation and Coding Scheme (MCS) fields;

FIG. 2 is a block diagram illustrating a configuration example of a part of a base station;

FIG. 3 is a block diagram illustrating a configuration example of a part of a terminal;

FIG. 4 is a diagram illustrating an exemplary relationship between received quality and configurations of Repetition and an MCS;

FIG. 5 is a flowchart illustrating an operation example related to configuration of Repetition and an MCS for Msg. 3 of the terminal;

FIG. 6 is a flowchart illustrating an operation example related to configuration of a transmission waveform of Msg. 3 of the terminal;

FIG. 7 is a diagram illustrating exemplary configuration values of the number of repetitions (referred to as “Repetition number” or “repetition number”) and an MCS index;

FIG. 8 is a diagram illustrating an exemplary relationship between received quality and configurations of Repetition and an MCS;

FIG. 9 is a flowchart illustrating an operation example related to configuration of Repetition and an MCS for Msg. 3 of the terminal;

FIG. 10 is a diagram illustrating an exemplary relationship between received quality and configurations of Repetition and an MCS;

FIG. 11 is a flowchart illustrating an operation example related to configuration of Repetition and an MCS for Msg. 3 of the terminal;

FIG. 12 is a diagram illustrating exemplary configuration values of Repetition number and an MCS index, and an exemplary scaling factor;

FIG. 13 is a block diagram illustrating a configuration example of the base station;

FIG. 14 is a block diagram illustrating a configuration example of the terminal;

FIG. 15 is a diagram illustrating an exemplary relationship between received quality and configurations of Repetition and an MCS;

FIG. 16 is a diagram of an exemplary architecture for a 3GPP NR system;

FIG. 17 is a schematic diagram illustrating functional separation between NG-RAN and 5GC;

FIG. 18 is a sequence diagram of Radio Resource Control (RRC) connection setup/reconfiguration procedure;

FIG. 19 schematically illustrates usage scenarios of enhanced Mobile BroadBand (eMBB), massive Machine Type Communications (mMTC), and Ultra Reliable and Low Latency Communications (URLLC); and

FIG. 20 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

In NR, e.g., in addition to a frequency band of 6 GHz or less, mainly within the 700 MHz to 3.5 GHz bands (e.g., may be referred to as Frequency Range 1 (FR1)), which has been used for cellular communication, a millimeter-wave band such as the 28 GHz or 39 GHz band capable of ensuring a wide band (e.g., may be referred to as Frequency Range 2 (FR2)) can be utilized (e.g., see NPL 1). Further, for example, in FR1, a high frequency band is possibly used compared with the frequency band used in Long Term Evolution (LTE) or 3rd Generation mobile communication systems (3G) such as the 3.5 GHz band.

The higher the frequency band is, the greater a radio wave propagation loss is, and thus, the received quality of radio waves is likely to deteriorate. Hence, in NR, for example, it is expected to ensure almost the same communication area (or coverage) as in the Radio Access Technology (RAT) such LTE or 3G, in other words, to ensure an appropriate communication quality when the high frequency band is used compared with LTE or 3G. For example, in 3GPP Release 17 (e.g., referred to as “Rel. 17”) and Release 18 (e.g., referred to as “Rel.18”), methods for improving coverage in NR have been studied (see, e.g., NPLs 2 and 3).

### [Regarding Random Access Procedure]

In NR, a terminal (e.g., also referred to as user equipment (UE)) transmits a random access channel (RACH) to a base station (e.g., also referred to as gNB) in cases such as during initial access (e.g., transition from RRC IDLE state to RRC CONNECTED state), when returning from RRC INACTIVE state to RRC CONNECTED state, when downlink data or uplink data is generated during connection (when the uplink synchronization state is non-synchronized in RRC CONNECTED state), when requesting on-demand System Information (SI), or when recovering from a beam connection failure (Beam failure recovery). Thus, a connection from the terminal to the base station or re-synchronization establishment is attempted.

The sequence of operations performed for connection or re-synchronization establishment from a terminal to a base station is also referred to as a “Random access procedure” and may be composed of the following four steps in NR (see, e.g., NPL 6).

### <Step 1: Transmission of Message 1 (Msg. 1) or RACH Preamble>

The terminal randomly selects an RACH preamble resource to be actually used from a group of resource candidates (e.g., defined by a combination of time resources, frequency resources, and sequence resources) used for the transmission of the RACH preamble. The terminal then transmits a signal of a Physical Random Access Channel (PRACH) using the selected RACH preamble resource. Here, the RACH preamble is also referred to as “Message 1 (Msg.1).” Further, transmission of the RACH preamble is also referred to as “PRACH transmission.”

### <Step 2: Transmission of Message 2 (Msg.2)>

The base station transmits a RACH response (Random Access Response: RAR) when the base station detects a RACH preamble, for example. At this point, the base station cannot identify the terminal that has transmitted the RACH preamble. For this reason, RAR is transmitted to the entire cell covered by the base station. RAR may include, for example, information on a resource to be used by the terminal in uplink (transmission of Message 3 in Step 3 described later) or information on the transmission timing of uplink by the terminal. Here, RAR is also referred to as “Message 2 (Msg.2).”

Note that, in a case where the terminal that has transmitted the RACH preamble does not receive the RAR within a predetermined period (e.g., RAR reception window) since the transmission timing of the RACH preamble, the terminal may perform selecting a RACH preamble resource and transmitting the RACH preamble again (retransmission of Message 1).

### <Step 3: Transmission of Message 3 (Msg.3)>

The terminal transmits a signal (e.g., referred to as Message 3 (Msg.3)) including an RRC connection request or a scheduling request using an uplink resource indicated by the base station, for example, using RAR. Here, the uplink data channel (e.g., PUSCH: Physical Uplink Shared Channel) used for transmission of Message 3 is also referred to as “Msg. 3 PUSCH”.

### <Step 4: Transmission of Message 4 (Msg.4)>

The base station transmits a message including identification information (e.g., UE-ID) for identifying the terminal (e.g., referred to as Message 4 (Msg.4)) to the terminal. The base station confirms that a plurality of terminals is not in contention by transmitting Message 4 (contention resolution). Note that, for example, a Cell-Radio Network Temporary Identifier (C-RNTI) or a Temporary C-RNTI (TC-RNTI) may be used as the UE-ID.

Each step of Random access procedure has been described above.

In NR, Discrete Fourier Transform-spread-Orthogonal Frequency Division Multiplexing (DFT-s-OFDM) and Cyclic Prefix-OFDM (CP-OFDM) are supported as transmission waveforms of Msg. 3 PUSCH, for example. DFT-s-OFDM has a lower Peak-to-Average Power Radio (PAPR) of the transmission signal and higher power utilization efficiency than CP-OFDM, and thus has a transmission waveform that can ensure wide uplink coverage.

In NR up to Rel. 17, the transmission waveform of PUSCH is configured semi-statically by RRC (see, e.g., NPL 7). For example, the transmission waveform of Msg. 3 PUSCH may be determined based on a parameter (e.g., “msg3-transformPrecoder”) configured by cell-specific RRC.

In addition, in NR Rel. 17, repetition transmission (Repetition) to Msg. 3 PUSCH is applied as one of uplink coverage enhancement techniques (e.g., see NPL 6 and NPL 7). The terminal measures the received quality, for example, and determines that the coverage enhancement of Msg.3 is necessary when the received quality is equal to or less than a threshold value (e.g., “rsrp-ThresholdMsg3”), and requests the base station to perform Msg.3 PUSCH repetition.

Note that the received quality may be, for example, Reference Signal Received Power (RSRP), Reference Signal Received Quality (RSRQ), or Signal to Interference and Noise Ratio (SINR).

Further, when requesting Msg.3 PUSCH repetition, the terminal may use, for example, an RACH resource different from an existing RACH resource configured for the terminal. Thus, the base station can identify the terminal that requests Msg.3 PUSCH repetition.

The base station may determine whether to actually apply Repetition to the terminal that requests Msg.3 PUSCH repetition, based on information including, for example, the received quality of the RACH preamble. Further, the base station determines the number of Repetitions (referred to as “Repetition number” or “repetition number” hereinafter) based on information including, for example, the received quality of the RACH preamble, and indicates, to the terminal, the determined Repetition number through uplink allocation information (e.g., UL grant) included in RAR.

In Rel. 17, Repetition number of Msg.3 PUSCH is indicated by reusing the Modulation and Coding Scheme (MCS) field of the UL grant. For example, for a terminal that has requested Msg.3 PUSCH repetition, the Repetition number is indicated using 2 bits of the Most Significant Bit (MSB) of the 4-bit MCS field of the RAR UL grant, and the MCS index is indicated using 2 bits of the Least Significant Bit (LSB). At this time, there are four candidates for the configuration value of each of the Repetition number and the MCS index that may be indicated by the UL grant. The candidates for the configuration values (may be referred to as “configuration value candidates”) for Repetition number and the MCS index may be configured for the terminal by, for example, a System Information Block (SIB).

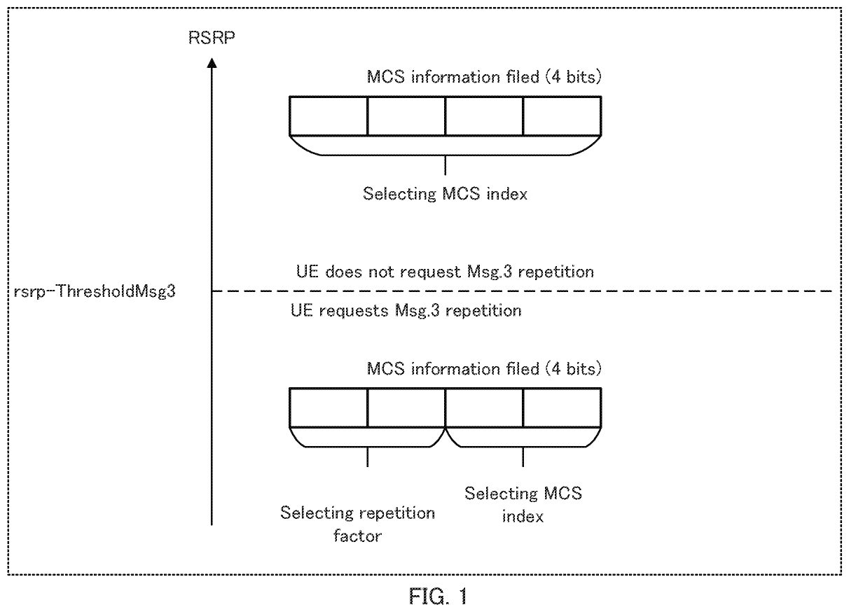

FIG. 1 is a diagram illustrating an example of a condition for requesting Msg.3 PUSCH repetition in Rel. 17 and a method for using an MCS field (e.g., MCS information field) of an RAR UL grant for scheduling Msg.3 PUSCH.

As illustrated in FIG. 1, in a case where the received quality (e.g., RSRP) is larger than a threshold value (e.g., rsrp-ThresholdMsg3), the terminal does not request Msg.3 PUSCH repetition and selects (or acquires, selects) the MCS index using 4 bits of the MCS field. Further, as illustrated in FIG. 1, in a case where RSRP is equal to or less than threshold value, rsrp-ThresholdMsg3, the terminal requests Msg.3 PUSCH repetition, selects the Repetition number (e.g., repetition factor) using 2 bits (e.g., 2 bits of MSB) of the MCS field, and selects the MCS index using the remaining 2 bits (e.g., 2 bits of LSB).

In a general cellular system, it is assumed that DFT-s-OFDM is configured for a terminal at the cell edge, where uplink coverage improvement is expected, to ensure coverage. Here, the transmission waveform of Msg. 3 PUSCH is determined based on msg3-transformPrecoder, which is a parameter configured by cell-specific RRC. Therefore, for example, in a case where DFT-s-OFDM suitable for a terminal for which coverage needs to be ensured is configured by cell-specific RRC, a terminal that can transmit the Msg. 3 PUSCH with a high received quality (e.g., SINR) ensured finds it difficult to perform high-efficiency transmission using CP-OFDM, and thus there is a possibility that spectral efficiency of the entire cell degrades. On the other hand, in a case where CP-OFDM is configured by cell-specific RRC, coverage performance of the terminal at the cell edge possibly deteriorates.

Therefore, in NR Rel. 18, dynamically switching the transmission waveform of PUSCH (dynamic transmission waveform switching) has been discussed (e.g., see NPL 3). Note that the dynamic transmission waveform switching may also be referred to as “dynamic waveform switching (DWS)”.

With the dynamic switching of transmission waveform, it is assumed that, for example, the terminal at the cell edge configures the transmission waveform of Msg. 3 PUSCH to DFT-s-OFDM without depending on the indication of the parameter (e.g., msg3-transformPrecoder) configured by cell-specific RRC.

Here, for example, in contention-based random access, a network (e.g., a base station) cannot know which terminal has transmitted Msg. 3 until the decoding of Msg. 3 succeeds. Therefore, for example, in a case where the network configures the transmission waveform of Msg. 3 PUSCH to CP-OFDM using msg3-transformPrecoder, the base station identifies, by blind detection, which one of the following terminals has transmitted Msg. 3: the terminal that configures the transmission waveform to CP-OFDM and transmits Msg. 3 (e.g., a terminal up to Rel. 17); and the terminal that has a capability to select the transmission waveform without depending on the indication of msg3-transformPrecoder and configures the transmission waveform to DFT-s-OFDM and transmits Msg. 3 (e.g., a terminal in Rel. 18). There is a possibility that the decoding processing of the base station increases due to this processing of identifying the terminal that transmits Msg. 3.

For example, in order to avoid an increase in decoding processing due to blind detection by the base station, introduction of the following method is possible: dividing the PRACH resource (e.g., RACH occasion or RACH preamble) (e.g., PRACH resource partitioning). In the PRACH resource partitioning, for example, it is assumed that the PRACH resource is divided between the PRACH resource of the terminal up to Rel. 17 and the terminal in Rel. 18 that has a capability to select the transmission waveform without depending on the indication of msg3-transformPrecoder and configures the transmission waveform to DFT-s-OFDM and transmits Msg. 3. As a result, the base station can identify the terminal that transmits Msg. 3 via the PRACH resource and thus need not perform blind detection of Msg. 3. However, the introduction of the PRACH resource partitioning increases an overhead of the RACH resource, which possibly leads to a decrease in utilization efficiency of the uplink resource.

In addition, in NR Rel. 18, in order to further improve the uplink coverage, for example, application of repetition transmission of PRACH (also referred to as, e.g., “multiple PRACH transmission” or “PRACH repetition”) has been discussed.

For example, there is room for discussion in the operation related to Msg.3 PUSCH transmission (e.g., the transmission control method for Msg.3 PUSCH) in a terminal to which multiple PRACH transmission or PRACH repetition is applied.

For example, it may be assumed that the terminal measures the received quality (e.g., RSRP, RSRQ, or SINR), and in a case where the measured received quality is equal to or less than a threshold value, the terminal determines that coverage enhancement of PRACH is necessary, and transmits PRACH with application of multiple PRACH transmission or PRACH repetition. At this time, the mutual relationship between the condition (e.g., received quality) for the terminal to apply multiple PRACH transmission or PRACH repetition and the condition (e.g., received quality) for the terminal to request Msg.3 PUSCH repetition is unclear.

For example, a case may be assumed where the condition (e.g., received quality) for the terminal to apply multiple PRACH transmission or PRACH repetition and the condition for the terminal to request Msg.3 PUSCH repetition are configured to be the same. However, since the conditions under which coverage improvement is required for PRACH and Msg.3 PUSCH may differ, there is a possibility that Repetition is applied to transmission for which no coverage improvement is required, leading to a potential degradation in uplink spectral efficiency.

In one non-limiting embodiment of the present disclosure, a method will be described in which a terminal transmits Msg. 3 PUSCH using an appropriate transmission waveform in a case where multiple PRACH transmission or PRACH repetition is applied, and a base station identifies the transmission waveform used by the terminal without using an additional PRACH resource.

For example, a mutual relationship between a condition for the terminal to apply the multiple PRACH transmission or the PRACH repetition (e.g., a condition related to a received quality) and a condition for the terminal to determine the transmission waveform to be DFT-s-OFDM (e.g., condition related to received quality) may be characterized.

In addition, in one non-limiting embodiment of the present disclosure, a method will be described in which a terminal transmits Msg. 3 PUSCH using an appropriate Repetition number or MCS in a case where multiple PRACH transmission or PRACH repetition is applied. For example, the mutual relationship between the following conditions may be characterized: a condition in which the terminal applies multiple PRACH transmission or PRACH repetition (e.g., a condition related to received quality); and a condition (or a condition for switching a method for determining the Repetition number or MCS for Msg.3 PUSCH repetition) in which the terminal requests Msg.3 PUSCH repetition (e.g., a condition related to received quality).

According to one non-limiting embodiment of the present disclosure, in an environment in which a terminal applies multiple PRACH transmission or PRACH repetition, the terminal can transmit Msg. 3 PUSCH using an appropriate transmission waveform, Repetition number, or MCS.

In addition, in one non-limiting embodiment of the present disclosure, for example, by allowing a method for determining the Repetition number or the MCS for a plurality of Msg. 3 PUSCH repetitions (e.g., a plurality of configuration value candidates (e.g., configured set)), the terminal can transmit Msg. 3 PUSCH using a transmission waveform, a Repetition number, or an MCS that is more suitable for the environment in which multiple PRACH transmission or PRACH repetition is applied.

Hereinafter, non-limiting embodiments of the present disclosure will be described.

### [Overview of Communication System]

A communication system according to each embodiment of the present disclosure includes, for example, at least one base station and at least one terminal.

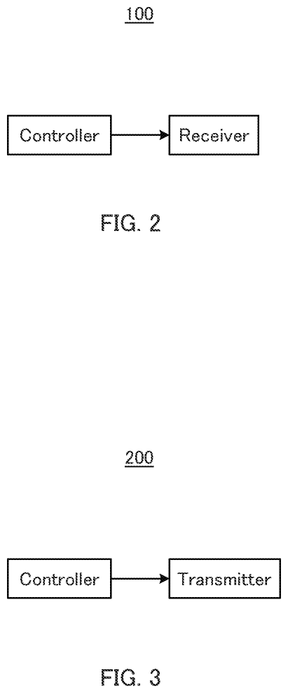

FIG. 2 is a block diagram illustrating a configuration example of a part of base station 100 according to an embodiment of the present disclosure, and FIG. 3 is a block diagram illustrating a configuration example of a part of terminal 200 according to an embodiment of the present disclosure.

In base station 100 illustrated in FIG. 2, a controller (e.g., corresponding to a control circuitry) configures, based on a condition related to repetition transmission of a first signal (e.g., PRACH), a transmission waveform of a second signal (e.g., Msg. 3 PUSCH). A receiver (e.g., corresponding to reception circuitry) receives the second signal based on the transmission waveform.

In terminal 200 illustrated in FIG. 3, a controller (e.g., corresponding to a control circuitry) configures, based on a condition related to repetition transmission of a first signal (e.g., PRACH), a transmission waveform of a second signal (e.g., Msg. 3 PUSCH). A transmitter (e.g., corresponding to a transmission circuitry) transmits the second signal using the transmission waveform.

### Embodiment 1

In the present embodiment, terminal 200 measures received quality (e.g., RSRP, RSRQ, or SINR), and when the measured received quality is equal to or less than a threshold value for PRACH (e.g., “rsrp-ThresholdPRACHrepetition”), terminal 200 determines that coverage enhancement for PRACH is necessary, and applies multiple PRACH transmission or PRACH repetition and transmits PRACH. Meanwhile, when the received quality is greater than the threshold value for PRACH, terminal 200 transmits PRACH without applying PRACH repetition.

In addition, for example, in a case where multiple PRACH transmission or PRACH repetition is applied, terminal 200 configures the transmission waveform of Msg. 3 PUSCH to DFT-s-OFDM. For example, in a case where PRACH is transmitted with application of multiple PRACH transmission or PRACH repetition, terminal 200 ignores the configuration of msg3-transformPrecoder and determines the transmission waveform of Msg. 3 PUSCH to be DFT-s-OFDM. On the other hand, for example, in a case where PRACH is transmitted without application of multiple PRACH transmission or PRACH repetition, terminal 200 determines the transmission waveform of Msg. 3 PUSCH based on the configuration of msg3-transformPrecoder.

In this case, terminal 200 that supports the capability for the multiple PRACH transmission or PRACH repetition may support a capability of selecting the transmission waveform without depending on (or without relying on) the indication of msg3-transformPrecoder. For example, the capability of selecting the transmission waveform without depending on the indication of msg3-transformPrecoder may be a capability of dynamically switching the transmission waveform of the Msg. 3 PUSCH or a capability of ignoring the configuration of CP-OFDM by msg3-transformPrecoder to the Msg. 3 PUSCH.

For example, different RACH resources may be configured for the RACH resource for PRACH to which no Repetition is applied and the RACH resource for the PRACH to which the multiple PRACH transmission or PRACH repetition is applied. As a result, base station 100 can identify (or distinguish) the transmission waveform of the Msg. 3 PUSCH transmitted by terminal 200 based on the presence or absence of RACH repetition identified based on the RACH resource for receiving PRACH. Therefore, in the present embodiment, base station 100 does not need an additional RACH resource to distinguish the transmission waveform of Msg. 3 PUSCH.

Further, terminal 200 measures, for example, the received quality (e.g., RSRP, RSRQ, or SINR), and when the measured received quality is equal to or less than a threshold value (e.g., “rsrp-ThresholdMsg3”) for Msg.3, terminal 200 determines that coverage enhancement for Msg.3 is necessary, and requests Msg.3 PUSCH repetition to base station 100. On the other hand, when the received quality is greater than the threshold value for Msg.3 PUSCH, terminal 200 does not request Msg.3 PUSCH repetition to base station 100.

In general, Msg.3 PUSCH is a channel for which coverage improvement is desired more than PRACH. Accordingly, in a case where terminal 200 applies multiple PRACH transmission or PRACH repetition, that is, in a case where it is determined that coverage improvement for PRACH is necessary, it is highly likely that coverage improvement is also necessary for Msg.3 PUSCH.

Accordingly, in the present embodiment, the threshold for PRACH (e.g., rsrp-ThresholdPRACHrepetition) may be configured to a value that does not exceed the threshold value for Msg.3 (e.g., rsrp-ThresholdMsg3). For example, the relationship may be rsrp-ThresholdPRACHrepetition<rsrp-ThresholdMsg3.

For example, when terminal 200 transmits PRACH with application of multiple PRACH transmission or PRACH repetition, terminal 200 also requests Msg.3 PUSCH repetition to base station 100. That is, when terminal 200 transmits PRACH with application of multiple PRACH transmission or PRACH repetition, terminal 200 determines that coverage enhancement of Msg.3 is necessary.

As described above, terminal 200 may perform transmission control of Msg. 3 PUSCH (e.g., control of the Msg. 3 PUSCH repetition or configuration of a transmission waveform of Msg. 3 PUSCH) based on a condition related to the repetition transmission of PRACH (e.g., a condition related to a received quality). For example, when the received quality (e.g., RSRP) is equal to or less than the threshold value rsrp-ThresholdPRACHrepetition, terminal 200 may determine to request Msg.3 PUSCH repetition in addition to the application of multiple PRACH transmission or PRACH repetition. In addition, for example, in a case where the received quality is equal to or less than the threshold value for PRACH, that is, in a case where the PRACH is transmitted with application of multiple PRACH transmission or PRACH repetition, terminal 200 may determine the transmission waveform of the Msg. 3 PUSCH to be DFT-s-OFDM.

Further, for example, in the present embodiment, base station 100 indicates, to terminal 200, which has requested Msg.3 PUSCH repetition, Repetition number using 2 bits of the MSB and of the MCS index using 2 bits of the LSB in the 4-bit MCS field of the RAR UL grant, regardless of the presence or absence of application of multiple PRACH transmission or PRACH repetition. Further, in a case where terminal 200 requests, for example, Msg.3 PUSCH repetition, terminal 200, regardless of the presence or absence of multiple PRACH transmissions or PRACH repetitions, determines Msg.3 PUSCH repetition number based on some of the bits (e.g., 2 bits of MSB) in the MCS field included in RAR UL grant for Msg.3 PUSCH and determines the MCS index based on the remaining bits (e.g., 2 bits of LSB) in the MCS field.

Note that, the configuration value candidates for the Repetition number and the MCS index that can be indicated by the UL grant are four each, and these candidates may be configured for terminal 200 by SIB.

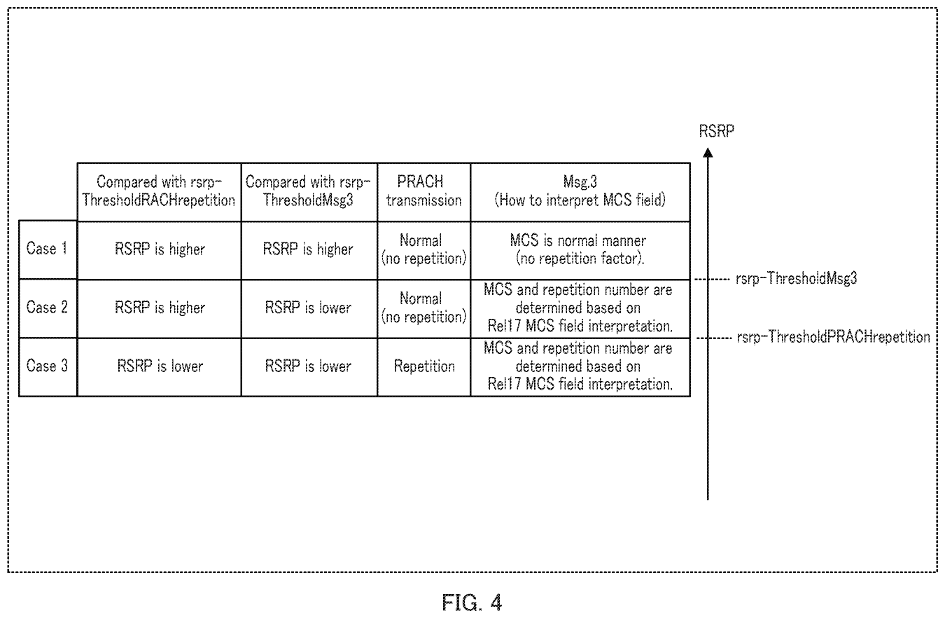

FIG. 4 is a diagram illustrating an example of the mutual relationship between the received quality with which multiple PRACH transmission or PRACH repetition is applied, the received quality with which terminal 200 requests Msg.3 PUSCH repetition, and the method for determining the Repetition number or MCS for Msg.3 PUSCH repetition in the present embodiment.

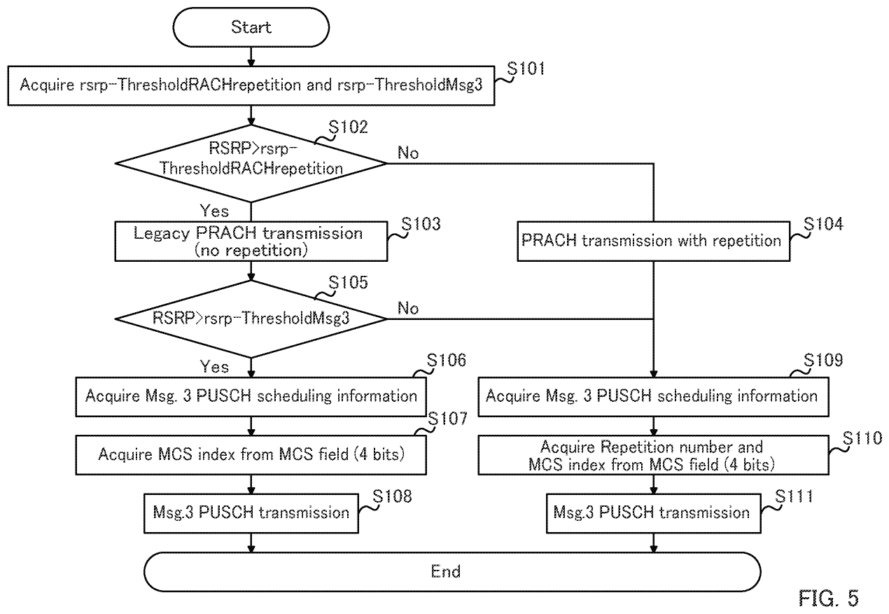

FIG. 5 is a flowchart illustrating an operation example related to configuration of Repetition and an MCS for Msg. 3 of terminal 200.

In FIG. 5, terminal 200 acquires control information from base station 100 (S101). The control information may include, for example, information on received quality with which multiple PRACH transmission or PRACH repetition is applied (e.g., rsrp-ThresholdPRACHrepetition), and information on received quality with which Msg.3 PUSCH repetition is requested (e.g., rsrp-ThresholdMsg3).

Terminal 200 measures the received quality (e.g., RSRP) and determines whether the measured RSRP is greater than the threshold value, rsrp-ThresholdPRACHrepetition (S102). Further, terminal 200 determines whether the measured RSRP is greater than threshold value, rsrp-ThresholdMsg3 (S105).

### <Case 1 in FIG. 4>

For example, in a case where the RSRP is larger than the threshold value, rsrp-ThresholdPRACHrepetition (S102: Yes) and the RSRP is larger than the threshold value, rsrp-ThresholdMsg3 (S105: Yes), terminal 200 does not apply multiple PRACH transmission or PRACH repetition (e.g., applies legacy PRACH transmission) (S103). Further, in this case, terminal 200 does not request Msg.3 PUSCH repetition to base station 100. Terminal 200 acquires, for example, scheduling information of the Msg. 3 PUSCH (e.g., RAR UL grant) (S106), acquires the MCS index using the 4-bit MCS field in the scheduling information (S107), and transmits the Msg. 3 PUSCH (S108).

### <Case 2 in FIG. 4>

For example, in a case where the RSRP is larger than rsrp-ThresholdPRACHrepetition (S102: Yes) and the RSRP is equal to or smaller than threshold value, rsrp-ThresholdMsg3 (S105: No), terminal 200 does not apply multiple PRACH transmission or PRACH repetition (e.g., applies legacy PRACH transmission) (S103). Further, in this case, terminal 200 requests Msg.3 PUSCH repetition to base station 100. Terminal 200 acquires, for example, scheduling information of the Msg. 3 PUSCH (e.g., RAR UL grant) (S109), acquires the Repetition number and the MCS index using the 4-bit MCS field in the scheduling information (S110), and transmits the Msg. 3 PUSCH (S111).

### <Case 3 in FIG. 4>

Further, for example, in a case where the RSRP is equal to or less than rsrp-ThresholdPRACHrepetition (S102: No), terminal 200 applies multiple PRACH transmission or PRACH repetition (S104) and requests Msg.3 PUSCH repetition to base station 100. Terminal 200 acquires, for example, scheduling information of the Msg. 3 PUSCH (e.g., RAR UL grant) (S109), acquires the Repetition number and the MCS index using the 4-bit MCS field in the scheduling information (S110), and transmits the Msg. 3 PUSCH (S111).

For example, in a case where the Repetition number and the MCS index are acquired using the 4-bit MCS field (S110 in FIG. 5), the Repetition number may be indicated to terminal 200 using 2 bits (e.g., 2 bits of MSB) of the MCS field of the RAR UL grant, and the MCS index may be indicated using the remaining 2 bits (e.g., 2 bits of LSB) of the MCS field.

The operation example related to the configuration of Repetition and the MCS of Msg. 3 of terminal 200 has been described above.

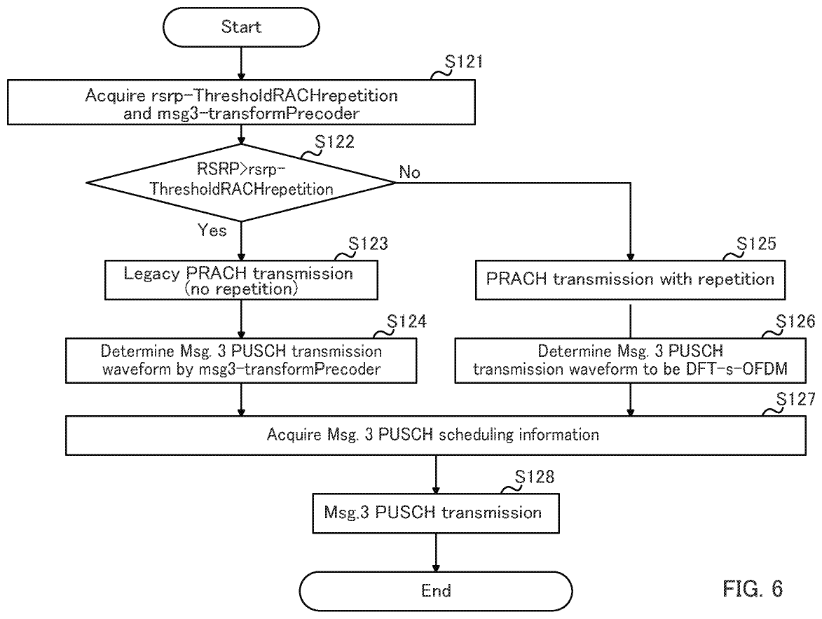

FIG. 6 is a flowchart illustrating an operation example related to configuration of a transmission waveform of Msg. 3 of terminal 200.

In FIG. 6, terminal 200 acquires control information from base station 100 (S121). The control information may include, for example, information related to received quality for applying the multiple PRACH transmission or the PRACH repetition (e.g., rsrp-ThresholdPRACHrepetition) and information related to configuration of a transmission waveform of the Msg. 3 PUSCH (e.g., msg3-transformPrecoder).

Terminal 200 measures a received quality (e.g., RSRP) and determines whether the measured RSRP is larger than a threshold value, rsrp-ThresholdPRACHrepetition (S122).

For example, in a case where the RSRP is larger than the threshold value, rsrp-ThresholdPRACHrepetition (S122: Yes), terminal 200 does not apply multiple PRACH transmission or PRACH repetition (e.g., applies legacy PRACH transmission) (S123). In addition, in this case, terminal 200 determines the transmission waveform of the Msg. 3 PUSCH based on msg3-transformPrecoder (S124).

On the other hand, for example, in a case where the RSRP is equal to or less than the threshold value, rsrp-ThresholdPRACHrepetition (S122: No), terminal 200 applies multiple PRACH transmission or PRACH repetition (S125). In addition, in this case, terminal 200 determines the transmission waveform of the Msg. 3 PUSCH to be DFT-s-OFDM without depending on the configuration of msg3-transformPrecoder (or while ignoring the configuration of msg3-transformPrecoder) (S126).

Then, terminal 200 acquires, for example, scheduling information of the Msg. 3 PUSCH (e.g., RAR UL grant) (S127), and transmits the Msg. 3 PUSCH based on the scheduling information (S128).

The operation example related to the configuration of the transmission waveform of Msg. 3 of terminal 200 has been described above.

In the present embodiment, terminal 200 configures the transmission waveform of the Msg. 3 PUSCH based on a condition for applying multiple PRACH transmission or PRACH repetition (e.g., comparison of RSRP with threshold value rsrp-ThresholdPRACHrepetition). For example, in a case where multiple PRACH transmission or PRACH repetition is applied, terminal 200 configures the transmission waveform of the Msg. 3 PUSCH to DFT-s-OFDM without depending on the configuration indicated from base station 100 (e.g., the configuration of msg3-transformPrecoder).

As a result, in a case where multiple PRACH transmission or PRACH repetition is applied, terminal 200 can transmit the Msg. 3 PUSCH using an appropriate transmission waveform. In addition, since base station 100 can identify terminal 200 that transmits Msg. 3 in accordance with the presence or absence of multiple PRACH transmission or PRACH repetition, base station 100 can avoid an increase in decoding processing (e.g., blind detection processing).

In addition, since terminal 200 configures the transmission waveform of the Msg. 3 PUSCH in accordance with the application of multiple PRACH transmission or PRACH repetition, base station 100 can identify the transmission waveform of the Msg. 3 PUSCH transmitted from terminal 200, for example, in accordance with the presence or absence of the application of multiple PRACH transmission or PRACH repetition. Therefore, according to the present embodiment, for example, since it is not necessary to use an additional PRACH resource by the method such as the PRACH resource partitioning, it is possible to suppress an increase in the overhead of the RACH resource and to improve the utilization efficiency of the uplink resource.

In addition, in the present embodiment, terminal 200 performs transmission control of Msg. 3 PUSCH repetition based on a condition for applying multiple PRACH transmission or PRACH repetition (e.g., comparison of RSRP with threshold value rsrp-ThresholdPRACHrepetition). Further, in a case where terminal 200 requests Msg.3 PUSCH repetition, terminal 200 selects Repetition number and the MCS index using the MCS field, regardless of the presence or absence of the application of multiple PRACH transmission or PRACH repetition.

Thus, in an environment where multiple PRACH transmission or PRACH repetition is applied, terminal 200 can be indicated of an appropriate value from the Repetition number and the MCS index configured for terminal 200 by SIB, and thus can transmit Msg.3 PUSCH.

Thus, according to the present embodiment, terminal 200 can transmit a signal appropriately in uplink.

### Embodiment 2

In Embodiment 1, a description has been given of a method for determining the Repetition number and MCS for Msg.3 PUSCH by the same method (e.g., the same configuration value candidates. MCS field interpretation in Rel. 17) for terminal 200 that has requested Msg.3 PUSCH repetition, regardless of the presence or absence of the application of multiple PRACH transmission or PRACH repetition.

For example, in an environment where the application of multiple PRACH transmission or PRACH repetition is necessary, it is assumed that the environment has a high degree of coverage improvement, and thus, it is desirable to transmit Msg.3 PUSCH with a larger Repetition number or with an MCS that allows transmission with a lower coding rate.

Accordingly, in the present embodiment, a description will be given of a case where a method for determining one set from a plurality of sets (e.g., configured sets) of configuration value candidates for the Repetition number and the MCS for Msg.3 PUSCH repetition is allowed.

For example, in addition to the existing configuration value candidates for the Repetition number and the MCS index that can be indicated by UL grant (hereinafter, also referred to as a “legacy configured set”), additional configuration value candidates different from the legacy configured set (hereinafter, referred to as an “additional configured set”) may be configured for terminal 200. Note that the legacy configured set and the additional configured set may be configured for terminal 200 by SIB, for example.

Further, in the present embodiment, terminal 200 may determine whether to use the legacy configured set or the additional configured set, based on a condition related to the received quality for performing multiple PRACH transmission or PRACH repetition (e.g., a comparison of received quality with threshold value). For example, a threshold value (e.g., rsrp-ThresholdPRACHrepetitionMoreLevel) for determining whether to use additional configuration value candidates (additional configured set) in the determination of Repetition number and the MCS for Msg.3 PUSCH repetition may be configured in terminal 200.

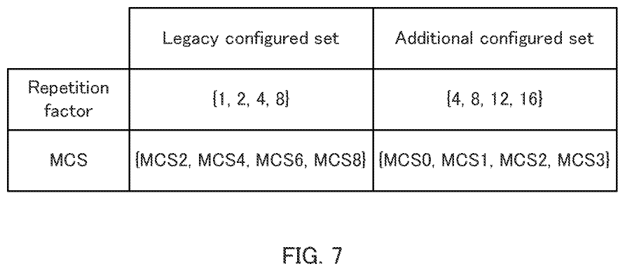

FIG. 7 is a diagram illustrating an example of the existing configuration value candidates for the Repetition number and the MCS index that can be indicated by UL grant (legacy configured set) and an example of the additional configuration value candidates for the Repetition number and the MCS index (additional configured set).

As illustrated in FIG. 7, the additional configured set may include, for example, the Repetition number having a larger value than the Repetition number included in the legacy configured set). In addition, as illustrated in FIG. 7, the additional configured set may include, for example, an MCS index smaller than the MCS index included in the legacy configured set.

Note that, in the present embodiment, an additional candidate may be configured for both the Repetition number and the MCS index, or an additional candidate may be configured for either one of them, and no additional candidates may be configured for the other.

For example, terminal 200 measures the received quality (e.g., RSRP, RSRQ, or SINR), and when the measured received quality is equal to or less than a threshold value for PRACH (e.g., rsrp-ThresholdPRACHrepetition), terminal 200 determines that coverage enhancement for PRACH is necessary, and applies multiple PRACH transmission or PRACH repetition to transmit PRACH.

In addition, for example, in a case where multiple PRACH transmission or PRACH repetition is applied, terminal 200 configures the transmission waveform of the Msg. 3 PUSCH to DFT-s-OFDM. For example, in a case where the PRACH is transmitted with application of multiple PRACH transmission or PRACH repetition, terminal 200 determines the transmission waveform of the Msg. 3 PUSCH to be DFT-s-OFDM while ignoring the configuration of msg3-transformPrecoder. On the other hand, for example, in a case where the PRACH is transmitted without applying multiple PRACH transmission or PRACH repetition, terminal 200 determines the transmission waveform of the Msg. 3 PUSCH based on the configuration of msg3-transformPrecoder.

In this case, terminal 200 that supports the capability of multiple PRACH transmission or PRACH repetition may support a capability of selecting the transmission waveform without depending on (or without relying on) the indication of msg3-transformPrecoder. For example, the capability of selecting the transmission waveform without depending on the indication of msg3-transformPrecoder may be a capability of dynamically switching the transmission waveform of the Msg. 3 PUSCH or a capability of ignoring the configuration of CP-OFDM by msg3-transformPrecoder to the Msg. 3 PUSCH.

For example, different RACH resources may be configured for the RACH resource for the PRACH to which no repetition is applied and the RACH resource for the PRACH to which multiple PRACH transmission or PRACH repetition is applied. As a result, base station 100 can identify (or distinguish) the transmission waveform of the Msg. 3 PUSCH transmitted by terminal 200 based on the presence or absence of the RACH repetition identified based on the RACH resource for receiving the PRACH. Therefore, in the present embodiment, base station 100 does not need an additional RACH resource to distinguish the transmission waveform of the Msg. 3 PUSCH.

Further, terminal 200 measures the received quality (e.g., RSRP, RSRQ, or SINR), and when the measured received quality is equal to or less than a threshold value for Msg.3 (e.g., rsrp-ThresholdMsg3), terminal 200 determines that coverage enhancement for Msg.3 is necessary and requests Msg.3 PUSCH repetition to base station 100.

Here, the threshold for PRACH (e.g., rsrp-ThresholdPRACHrepetition) may be configured to a value that does not exceed the threshold value for Msg.3 (e.g., rsrp-ThresholdMsg3) (e.g., rsrp-ThresholdPRACHrepetition<rsrp-ThresholdMsg3). Further, for example, when terminal 200 transmits PRACH with application of multiple PRACH transmission or PRACH repetition in the same manner as in Embodiment 1, terminal 200 may also request Msg.3 PUSCH repetition to base station 100.

Further, in the present embodiment, base station 100 indicates, to terminal 200, the Repetition number using 2 bits of the MSB in the 4-bit MCS field of the RAR UL grant, and indicates, to terminal 200, the MCS index using 2 bits of the LSB in the 4 bits of the MCS field of the RAR UL grant, for example. Note that, the configuration value candidates for each of the Repetition number and the MCS index that can be indicated by the UL grant are four.

At this time, for example, terminal 200 determines the Repetition number and the MCS index based on the indication of the MCS field of the UL grant and the existing candidates for the values of the Repetition number and the MCS index (e.g., legacy configured set) in a case where the received quality is larger than a threshold value for determining whether to use additional configuration value candidates (additional configured set) (e.g., rsrp-ThresholdPRACHrepetitionMoreLevel), for example.

On the other hand, terminal 200 determines the Repetition number and the MCS index based on the indication of the MCS field of the UL grant and the additional configuration value candidates (e.g., additional configured set) in a case where the received quality is equal to or less than the threshold value, rsrp-ThresholdPRACHrepetitionMoreLevel, for example.

Here, for example, the threshold value, rsrp-ThresholdPRACHrepetitionMoreLevel may be configured to a value that does not exceed a threshold for PRACH (e.g., rsrp-ThresholdPRACHrepetition). For example, the relationship may be rsrp-ThresholdPRACHrepetitionMoreLevel<rsrp-ThresholdPRACHrepetition<rsrp-ThresholdMsg3. As described above, terminal 200 may perform transmission control of the Msg. 3 PUSCH (e.g., selection of a configuration value candidate set in the Msg. 3 PUSCH repetition or configuration of a transmission waveform of the Msg. 3 PUSCH) based on a condition related to the repetition transmission of the PRACH (e.g., comparison of the received quality with the threshold value).

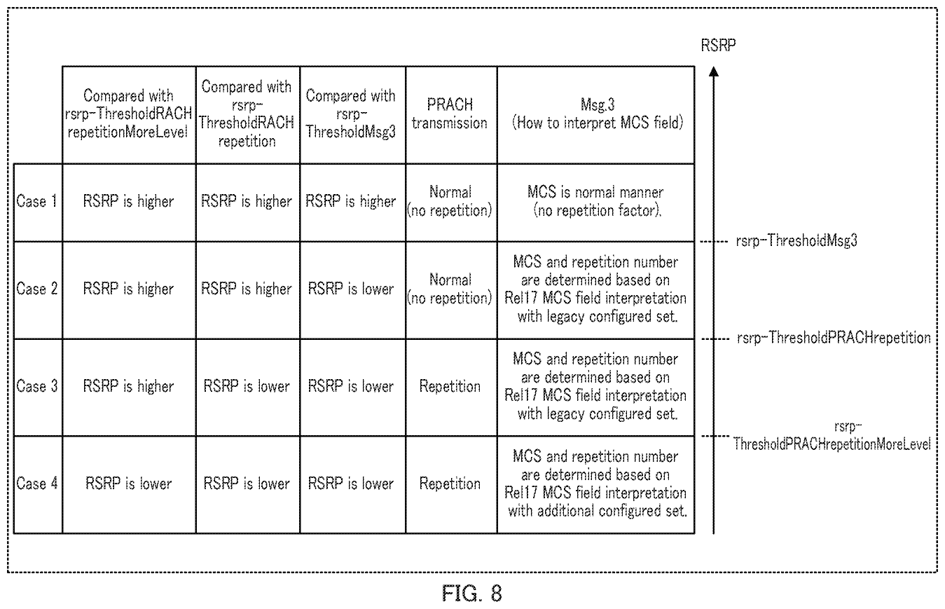

FIG. 8 is a diagram illustrating an example of a mutual relationship between a received quality for applying multiple PRACH transmission or PRACH repetition, a received quality for requesting Msg. 3 PUSCH repetition by terminal 200, and a method for determining the Repetition number or MCS for Msg.3 PUSCH repetition in the present embodiment.

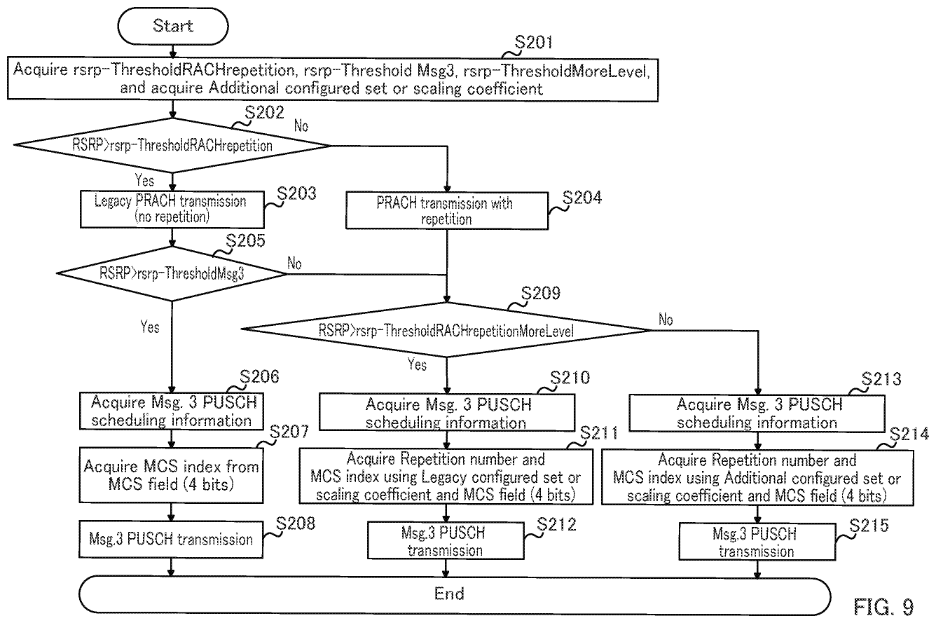

In addition, FIG. 9 is a flowchart illustrating an operation example related to configuration of Repetition and the MCS for Msg. 3 of terminal 200.

In FIG. 9, terminal 200 acquires control information from base station 100 (S201). The control information may include, for example, a threshold value for received quality for determining whether to apply PRACH repetition (rsrp-ThresholdPRACHrepetition), a threshold for received quality for determining whether to apply Msg.3 PUSCH repetition (rsrp-ThresholdMsg3), a threshold for RSRP for determining whether to use additional configuration value candidates (e.g., “rsrp-ThresholdPRACHrepetitionMoreLevel”), and information on the additional configuration value candidates (additional configured set).

Terminal 200 measures the received quality (e.g., RSRP) and determines whether the measured RSRP is greater than threshold value, rsrp-ThresholdPRACHrepetition (S202). Further, terminal 200 determines whether the measured RSRP is greater than threshold value rsrp-ThresholdMsg3 (S205). Further, terminal 200 determines whether the measured RSRP is greater than threshold value rsrp-ThresholdRACHrepetitionMoreLevel (S209).

### <Case 1 of FIG. 8>

For example, in a case where the RSRP is larger than the threshold value, rsrp-ThresholdPRACHrepetition (S202: Yes) and the RSRP is larger than the threshold value, rsrp-ThresholdMsg3 (S205: Yes), terminal 200 does not apply multiple PRACH transmission or PRACH repetition (e.g., applies legacy PRACH transmission) (S203). Further, in this case, terminal 200 does not request Msg.3 PUSCH repetition to base station 100. Terminal 200 acquires, for example, scheduling information of the Msg. 3 PUSCH (e.g., RAR UL grant) (S206), acquires the MCS index using 4 bits of the MCS field in the scheduling information (S207), and transmits the Msg. 3 PUSCH (S208).

### <Case 2 of FIG. 8>

For example, in a case where the RSRP is larger than rsrp-ThresholdPRACHrepetition (S202: Yes), the RSRP is equal to or less than the threshold rSRP-ThresholdMsg3 (S205: No), than the threshold value, rsrp- and the RSRP is larger ThresholdPRACHrepetitionMoreLevel (S209: Yes), terminal 200 does not apply multiple PRACH transmission or PRACH repetition (e.g., applies legacy PRACH transmission) (S203). Further, in this case, terminal 200 requests Msg.3 PUSCH repetition to base station 100. Terminal 200 acquires, for example, scheduling information of the Msg. 3 PUSCH (e.g., RAR UL grant) (S210), acquires the Repetition number and the MCS index based on the 4-bit MCS field in the scheduling information and the legacy configured set (S211), and transmits the Msg. 3 PUSCH (S212).

### <Case 3 of FIG. 8>

For example, in a case where RSRP is equal to or less than rsrp-ThresholdPRACHrepetition (S202: No) and the RSRP is larger than threshold value, rsrp-ThresholdPRACHrepetitionMoreLevel (S209: Yes), terminal 200 applies multiple PRACH transmission or PRACH repetition (S204) and requests Msg.3 PUSCH repetition to base station 100. Terminal 200 acquires, for example, scheduling information of the Msg. 3 PUSCH (e.g., RAR UL grant) (S210), acquires the Repetition number and the MCS index based on the 4-bit MCS field in the scheduling information and the legacy configured set (S211), and transmits the Msg. 3 PUSCH (S212).

### <Case 4 of FIG. 8>

For example, in a case where RSRP is equal to or less than rsrp-ThresholdPRACHrepetition (S202: No) and the RSRP is equal to or less than threshold value, rsrp-ThresholdPRACHrepetitionMoreLevel (S209: No), terminal 200 applies multiple PRACH transmission or PRACH repetition (S204) and requests Msg.3 PUSCH repetition to base station 100. Terminal 200 acquires, for example, scheduling information of the Msg. 3 PUSCH (e.g., RAR UL grant) (S213), acquires the Repetition number and the MCS index based on the 4-bit MCS field in the scheduling information and the additional configured set (S214), and transmits the Msg. 3 PUSCH (S215).

The operation example related to the configuration of Repetition and the MCS for Msg. 3 of terminal 200 has been described above.

The operation example related to the transmission waveform configuration of Msg. 3 of terminal 200 may be the same as that in Embodiment 1 (e.g., FIG. 6). For example, terminal 200 determines the transmission waveform of Msg. 3 PUSCH based on msg3-transformPrecoder in a case where the received quality (e.g., RSRP) is larger than the threshold value, rsrp-ThresholdPRACHrepetition, and determines the transmission waveform of the Msg. 3 PUSCH to be DFT-s-OFDM without depending on the configuration of msg3-transformPrecoder in a case where the received quality (e.g., RSRP) is equal to or less than the threshold value, rsrp-ThresholdPRACHrepetition.

In the present embodiment, terminal 200 configures the transmission waveform of the Msg. 3 PUSCH based on a condition for applying multiple PRACH transmission or PRACH repetition (e.g., comparison of RSRP with threshold value rsrp-ThresholdPRACHrepetition). For example, in a case where multiple PRACH transmission or PRACH repetition is applied, terminal 200 configures the transmission waveform of the Msg. 3 PUSCH to DFT-s-OFDM without depending on the configuration indicated from base station 100 (e.g., the configuration of msg3-transformPrecoder).

As a result, in a case where multiple PRACH transmission or PRACH repetition is applied, terminal 200 can transmit the Msg. 3 PUSCH using an appropriate transmission waveform. In addition, since base station 100 can identify terminal 200 that transmits Msg. 3 in accordance with the presence or absence of the application of multiple PRACH transmission or PRACH repetition, base station 100 can avoid an increase in decoding processing (e.g., blind detection processing).

In addition, since terminal 200 configures the transmission waveform of the Msg. 3 PUSCH in accordance with the application of multiple PRACH transmission or PRACH repetition, base station 100 can identify the transmission waveform of the Msg. 3 PUSCH transmitted from terminal 200, for example, in accordance with the presence or absence of the application of multiple PRACH transmission or PRACH repetition. Therefore, according to the present embodiment, for example, since it is not necessary to use the additional PRACH resource by the method such as the PRACH resource partitioning, it is possible to suppress an increase in the overhead of the RACH resource and to improve the uplink resource utilization efficiency.

In addition, according to the present embodiment, terminal 200 performs the transmission control of Msg. 3 PUSCH repetition based on a condition for applying multiple PRACH transmission or PRACH repetition (e.g., comparison of RSRP with threshold value, rsrp-ThresholdPRACHrepetition or rsrp-ThresholdPRACHrepetitionMoreLevel). Further, terminal 200 determines one set from the legacy configured set and the additional configured set for the Repetition number and the MCS index of the Msg.3 PUSCH repetition transmission based on a condition for applying multiple PRACH transmission or PRACH repetition.

Thus, in an environment where multiple PRACH transmission or PRACH repetition is applied, terminal 200 can be indicated of an appropriate value from the Repetition number and the MCS index configured for terminal 200 by SIB, and thus can transmit Msg.3 PUSCH.

Further, for example, in an environment where the degree of coverage improvement requiring the application of multiple PRACH transmission or PRACH repetition is high (e.g., when RSRP is equal to or less than threshold value, rsrp-ThresholdPRACHrepetitionMoreLevel), terminal 200 can transmit Msg.3 PUSCH using an MCS that allows for a larger Repetition number or a lower coding rate.

Thus, according to the present embodiment, terminal 200 can transmit a signal appropriately in uplink.

Note that, in the present embodiment, the threshold value for determining whether to use additional configuration value candidates (e.g., rsrp-ThresholdPRACHrepetitionMoreLevel) may be configured to the same value as the threshold for PRACH (e.g., rsrp-ThresholdPRACHrepetition). In this case, terminal 200 may determine whether to use the additional configuration value candidates depending on whether to apply multiple PRACH transmission or PRACH repetition. For example, the set of configuration values (configured set) of the Repetition number and the MCS index may be different between a case where multiple PRACH transmission or PRACH repetition is applied and a case where no multiple PRACH transmission or PRACH repetition is applied.

Further, even in a case where a threshold value for determining whether to use the additional configuration value candidates (e.g., rsrp-ThresholdPRACHrepetitionMoreLevel) is not configured in terminal 200, terminal 200 may determine whether to use the additional configuration value candidates according to whether to apply multiple PRACH transmission or PRACH repetition, for example.

In addition, in the present embodiment, as an example, a case has been described in which one set of additional configuration value candidates (additional configured set) is configured in terminal 200 as illustrated in FIG. 7, but a plurality of additional configured sets may be configured in terminal 200. In this case, for example, a plurality of threshold values (e.g., rsrp-ThresholdPRACHrepetitionMoreLevel) for determining whether to use additional configuration value candidates may be configured.

### Embodiment 3

In the present embodiment, a description will be given of a case where a method for determining one set from a plurality of sets of configuration value candidates for Repetition number or MCS for Msg.3 PUSCH repetition (e.g., configured sets) is allowed in the same manner as in Embodiment 2.

For example, in addition to the existing configuration value candidates for the Repetition number and the MCS index that can be indicated by UL grant (e.g., a legacy configured set), an additional configuration value candidates different from the legacy configured set (e.g., an additional configured set) may be configured in terminal 200. The legacy configured set and the additional configured set may be configured in terminal 200 by, for example, SIB.

Further, in the present embodiment, terminal 200 may determine whether to use the legacy configured set or the additional configured set, based on a condition related to a level of multiple PRACH transmission or PRACH repetition (e.g., also referred to as a PRACH repetition level, a PRACH coverage level, or a PRACH coverage enhancement level) (e.g., a comparison of a level with a threshold value). For example, a parameter indicating a level for determining whether to use an additional configuration value candidate in the determination of the Repetition number or MCS for Msg.3 PUSCH repetition (e.g., “level-prach-For-msg3repetition”) may be configured.

For example, in the present embodiment, the example of the existing configuration value candidates for the Repetition number and the MCS index (legacy configured set) and the example of the additional configuration value candidates for the Repetition number and the MCS index may be the same as those in Embodiment 2 (e.g., FIG. 7). The additional configuration value candidates may include, for example, a Repetition number that is larger than the Repetition number included in the existing configuration value candidates. Further, the additional configuration value candidates may include, for example, an MCS index that is smaller than the MCS index included in the existing configuration value candidates. Note that, in the present embodiment, additional candidates may be configured for both the Repetition number and the MCS index, or additional candidates may be configured for either one of them, and no additional candidates may be configured for the other.

For example, terminal 200 measures the received quality (e.g., RSRP, RSRQ, or SINR), and when the measured received quality is equal to or less than a threshold value for PRACH (e.g., rsrp-ThresholdPRACHrepetition), terminal 200 determines that coverage enhancement for PRACH is necessary, and applies multiple PRACH transmission or PRACH repetition and transmits the PRACH.

Here, in the present embodiment, a plurality of threshold values for PRACH may be configured. For example, a plurality of PRACH repetition levels or PRACH coverage enhancement levels with different PRACH repetition numbers may be configured. For example, “rsrp-ThresholdPRACHrepetition1” and “rsrp-ThresholdPRACHrepetition2” (e.g., rsrp-ThresholdPRACHrepetition1>rsrp-ThresholdPRACHrepetition2) may be configured.

For example, when the received quality is greater than rsrp-ThresholdPRACHrepetition1, PRACH coverage level 0 (a level with which no PRACH repetition is applied) is configured, when the received quality is equal to or less than rsrp-ThresholdPRACHrepetition1 and greater than rsrp-ThresholdPRACHrepetition2, PRACH coverage level 1 (a level with which PRACH repetition is applied) is configured, and when the received quality is equal to or less than rsrp-ThresholdPRACHrepetition2, PRACH coverage level 2 (e.g., a level with which PRACH repetition is applied and a level in which Repetition number is larger than that in PRACH coverage level 1) may be configured.

In addition, for example, in a case where terminal 200 transmits PRACH with application of multiple PRACH transmission or PRACH repetition, terminal 200 may determine the transmission waveform of the Msg. 3 PUSCH based on the PRACH repetition level, the PRACH coverage enhancement level, the PRACH repetition number, or the received quality. For example, in a case where the PRACH repetition level, the PRACH coverage enhancement level, or the PRACH repetition number is equal to or less than a threshold value (or when the received quality is larger than the threshold value), terminal 200 determines the transmission waveform of the Msg. 3 PUSCH based on the configuration of msg3-transformPrecoder. On the other hand, for example, in a case where the PRACH repetition level, the PRACH coverage enhancement level, or the PRACH repetition number is larger than the threshold value (or when the received quality is equal to or less than the threshold value), terminal 200 determines the transmission waveform of the Msg. 3 PUSCH to be DFT-s-OFDM while ignoring the configuration of msg3-transformPrecoder.

Here, a threshold value may be configured for terminal 200 by the cell-specific RRC (e.g., the SIB) or may be a value determined in advance by the standard, the threshold being one for determining whether to configure DFT-s-OFDM as the transmission waveform of the Msg. 3 PUSCH without considering the configuration of msg3-transformPrecoder or whether to configure the transmission waveform configured by msg3-transformPrecoder as the transmission waveform of the Msg. 3 PUSCH (e.g., the PRACH repetition level, the PRACH coverage enhancement level, the PRACH repetition number, or the received quality).

In addition, terminal 200 that supports the capability of multiple PRACH transmission or PRACH repetition may support a capability of selecting the transmission waveform without depending on (or without relying on) the indication of msg3-transformPrecoder. For example, the capability of selecting the transmission waveform without depending on the indication of msg3-transformPrecoder may be a capability of dynamically switching the transmission waveform of the Msg. 3 PUSCH or a capability of ignoring the configuration of CP-OFDM by msg3-transformPrecoder to the Msg. 3 PUSCH.

For example, a different RACH resource may be configured for each of the PRACH repetition levels, the PRACH coverage enhancement levels, or the PRACH repetition numbers. As a result, base station 100 can identify (or distinguish) the transmission waveform of the Msg. 3 PUSCH transmitted by terminal 200, based on the PRACH repetition level, the PRACH coverage enhancement level, the PRACH repetition number, or the received quality identified based on the RACH resource for receiving the PRACH. Therefore, in the present embodiment, base station 100 does not need an additional RACH resource to distinguish the transmission waveform of the Msg. 3 PUSCH.

Further, terminal 200 measures the received quality (e.g., RSRP, RSRQ, or SINR), and when the measured received quality is equal to or less than a threshold value for Msg.3 (e.g., rsrp-ThresholdMsg3), terminal 200 determines that coverage enhancement for Msg.3 is necessary and requests Msg.3 PUSCH repetition to base station 100.

Here, the threshold value for PRACH (e.g., rsrp-ThresholdPRACHrepetition) may be configured to a value that does not exceed the threshold for Msg.3 (e.g., rsrp-ThresholdMsg3) (e.g., rsrp-ThresholdMsg3>rsrp-ThresholdPRACHrepetition1, rsrp-ThresholdPRACHrepetition2). Further, for example, when terminal 200 transmits PRACH with application of multiple PRACH transmission or PRACH repetition terminal 200 may also request Msg.3 PUSCH repetition to base station 100 in the same manner as in Embodiment 1.

Further, in the present embodiment, base station 100 indicates, to terminal 200, the Repetition number using 2 bits of the MSB of the 4-bit MCS field of the RAR UL grant, and indicates, to terminal 200, the MCS index using 2 bits of the LSB of the 4-bit MCS field of the RAR UL grant, for example. In this case, the configuration value candidates for the Repetition number and the MCS index that can be indicated by the UL grant are four each.

At this time, for example, terminal 200 determines the Repetition number and the MCS index based on the indication of the MCS field of the UL grant and the existing candidates for the values of the Repetition number and MCS index (e.g., legacy configured set) in a case where the PRACH coverage level is smaller than a threshold value for determining whether to use additional configuration value candidates (additional configured set) (e.g., level-prach-For-msg3repetition).

On the other hand, terminal 200 determines Repetition number and the MCS index based on the indication of the MCS field of the UL grant and additional configuration value candidates (e.g., additional configured set) in a case where the PRACH coverage level is equal to or greater than the threshold value, level-prach-For-msg3repetition, for example.

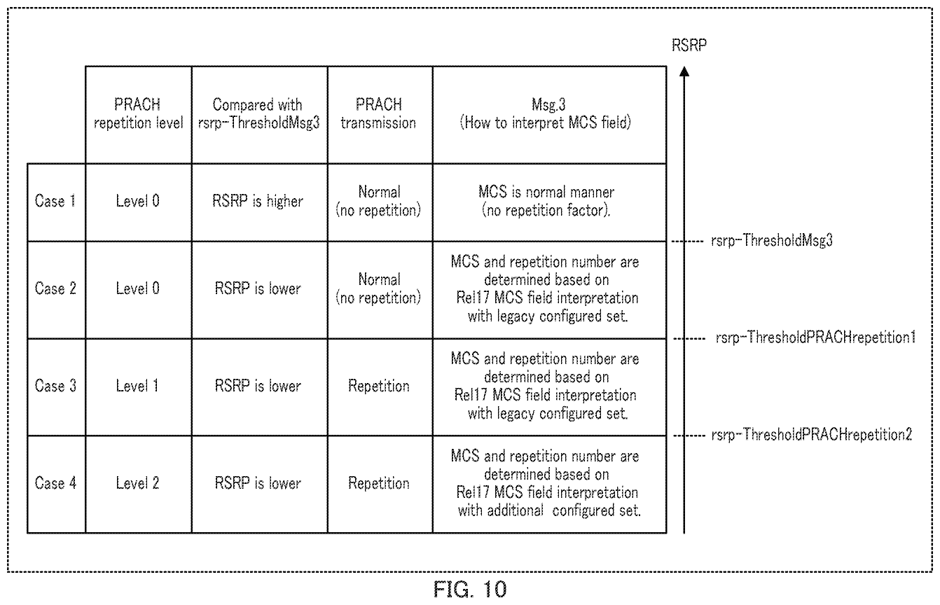

FIG. 10 is a diagram illustrating an example of a mutual relationship between a received quality for applying multiple PRACH transmission or PRACH repetition, a PRACH coverage level, received quality for terminal 200 to request the Msg. 3 PUSCH repetition, and a method for determining the Repetition number or MCS for Msg.3 PUSCH repetition in the present embodiment.

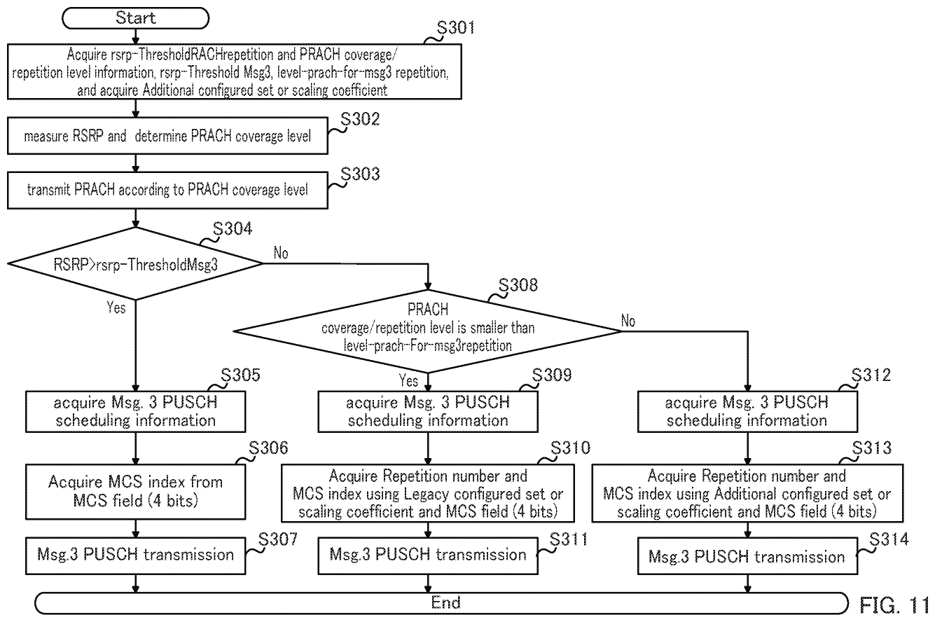

In addition, FIG. 11 is a flowchart illustrating an operation example related to configuration of Repetition and the MCS for Msg. 3 of terminal 200.

In FIG. 11, terminal 200 acquires control information from base station 100 (S301). The control information may include, for example, a threshold value for the received quality for determining whether to apply PRACH repetition (rsrp-ThresholdPRACHrepetition1, rsrp-ThresholdPRACHrepetition2), and information on a PRACH coverage level or a PRACH repetition level. Further, the control information may include, for example, a threshold value for the received quality for determining whether to apply Msg.3 PUSCH repetition (rsrp-ThresholdMsg3), a threshold for determining whether to use additional configuration value candidates (e.g., level-prach-For-msg3repetition), and information on additional configuration value candidates (additional configured set).

Terminal 200 measures the received quality (e.g., RSRP), compares the measured RSRP with a threshold value for PRACH (rsrp-ThresholdPRACHrepetition1, rsrp-ThresholdPRACHrepetition2), and determines the PRACH coverage level (S302). For example, terminal 200 may configure the PRACH coverage level 0 (Level 0) in a case where the RSRP is larger than rsrp-ThresholdPRACHrepetition1 (cases 1 and 2 in FIG. 10). In addition, for example, terminal 200 may configure the PRACH coverage level 1 (Level 1) in a case where the RSRP is equal to or less than rsrp-ThresholdPRACHrepetition1 and larger than rsrp-ThresholdPRACHrepetition2 (case 3 in FIG. 10). In addition, for example, terminal 200 may configure the PRACH coverage level 2 (Level 2) in a case where the RSRP is equal to or less than rsrp-ThresholdPRACHrepetition2 (case 4 in FIG. 10).

For example, terminal 200 determines the transmission of PRACH (e.g., multiple PRACH transmission or PRACH repetition) according to the determined PRACH coverage level (S303). For example, in the example of FIG. 10, when the PRACH coverage level is Level 1 or higher (case 3 and case 4), terminal 200 determines to apply multiple PRACH transmission or PRACH repetition, and when the PRACH coverage level is Level 0 (case 1 and case 2), terminal 200 determines not to apply multiple PRACH transmission or PRACH repetition.

Terminal 200 determines whether the measured RSRP is greater than the threshold value, rsrp-ThresholdMsg3 (S304). Further, terminal 200 determines whether the determined PRACH coverage level is smaller than the threshold value, level-prach-For-msg3repetition (S308). In the example of FIG. 10, level-prach-For-msg3repetition is configured with Level 2.

### <Case 1 of FIG. 10>

For example, when RSRP is larger than the threshold value, rsrp-ThresholdMsg3 (S304: Yes), terminal 200 acquires the scheduling information of Msg.3 PUSCH (e.g., RAR UL grant) (S305), acquires the MCS index using 4 bits of the MCS field in the scheduling information (S306), and transmits Msg.3 PUSCH (S307).

### <Cases 2 and 3 of FIG. 10>

For example, when the RSRP is equal to or less than the threshold value, rsrp-ThresholdMsg3 (S304: No) and the PRACH coverage level is smaller than the threshold value, level-prach-For-msg3repetition (Level 2 in FIG. 10) (S308: Yes), terminal 200 acquires scheduling information of the Msg. 3 PUSCH (e.g., RAR UL grant) (S309), acquires the Repetition number and the MCS index based on 4 bits of the MCS field in the scheduling information and the legacy configured set (S310), and transmits the Msg. 3 PUSCH (S311).

### <Case 4 of FIG. 10>

For example, when the RSRP is equal to or less than the threshold value, rsrp-ThresholdMsg3 (S304: No) and the PRACH coverage level is equal to or larger than the threshold value, level-prach-For-msg3repetition (Level 2 in FIG. 10) (S308: No), terminal 200 acquires scheduling information of the Msg. 3 PUSCH (e.g., RAR UL grant) (S312), acquires the Repetition number and the MCS index based on 4 bits of the MCS field in the scheduling information and the additional configured set (S313), and transmits the Msg. 3 PUSCH (S314).

In the present embodiment, terminal 200 configures the transmission waveform of the Msg. 3 PUSCH based on a condition for applying multiple PRACH transmission or PRACH repetition (e.g., comparison of the PRACH repetition level, the PRACH coverage enhancement level, the PRACH repetition number, or the received quality with the threshold value). For example, when the PRACH repetition level, the PRACH coverage enhancement level, or the PRACH repetition number is larger than the threshold value (or when the received quality is equal to or less than the threshold value), terminal 200 configures the transmission waveform of the Msg. 3 PUSCH to DFT-s-OFDM without depending on the configuration indicated from base station 100 (e.g., the configuration of msg3-transformPrecoder).

As a result, when multiple PRACH transmission or PRACH repetition is applied, terminal 200 can transmit the Msg. 3 PUSCH using an appropriate transmission waveform. In addition, since base station 100 can identify terminal 200 that transmits Msg. 3 in accordance with the presence or absence of the application of multiple PRACH transmission or PRACH repetition, base station 100 can avoid an increase in decoding processing (e.g., blind detection processing).

In addition, since terminal 200 configures the transmission waveform of the Msg. 3 PUSCH in accordance with the application of multiple PRACH transmission or PRACH repetition, base station 100 can identify the transmission waveform of the Msg. 3 PUSCH transmitted from terminal 200, for example, in accordance with the presence or absence of the application of multiple PRACH transmission or PRACH repetition. Therefore, according to the present embodiment, for example, since it is not necessary to use an additional PRACH resource by the method such as PRACH resource partitioning, it is possible to suppress an increase in the overhead of the RACH resource and to improve the uplink resource utilization efficiency.

In addition, according to the present embodiment, terminal 200 performs transmission control of the Msg. 3 PUSCH repetition based on a condition related to multiple PRACH transmission or PRACH repetition (e.g., comparison of the PRACH coverage level with the threshold value, level-prach-For-msg3repetition). Further, terminal 200 determines one set from the legacy configured set and the additional configured set for the Repetition number and the MCS index for the Msg.3 PUSCH repetition transmission, based on a condition related to multiple PRACH transmission or PRACH repetition.

Thus, in an environment where multiple PRACH transmission or PRACH repetition is applied, terminal 200 can be indicated an appropriate value from the Repetition number and the MCS index configured for terminal 200 by SIB and can transmit Msg.3 PUSCH.

Further, for example, in an environment where the degree of coverage improvement requiring the application of multiple PRACH transmission or PRACH repetition is high (e.g., when the RSRP is equal to or less than the threshold value, rsrp-ThresholdPRACHrepetitionMoreLevel), terminal 200 can transmit Msg.3 PUSCH using an MCS that allows for a larger Repetition number or a lower coding rate.

Thus, according to the present embodiment, terminal 200 can transmit a signal appropriately in uplink.

Note that, in the present embodiment, the PRACH coverage level may be Predefined. The coverage level for determining whether to use additional configuration value candidates in the determination of Repetition number and the MCS for Msg.3 PUSCH repetition may be configured for terminal 200 by SIB or may be a coverage level defined by the standard.

In addition, in the example of FIG. 10, a case has been described in which two threshold values for the received quality for configuration the PRACH coverage level (rsrp-ThresholdPRACHrepetition) are configured, but one or three or more threshold values may be configured for this threshold. In addition, in the example of FIG. 10, a case has been described in which three types (Levels 0 to 2) of the PRACH coverage levels are configured, but two types of the PRACH coverage levels may be configured, or four or more types of the PRACH coverage levels may be configured.

Further, for example, in the present embodiment, a case where one set of additional configuration value candidates (additional configured set) is configured has been described as an example, but a plurality of additional configured sets may be configured in terminal 200. In this case, a plurality of threshold values, level-prach-For-msg3repetition may be configured, for example.

In addition, in the present embodiment, for example, when the PRACH repetition level, the PRACH coverage enhancement level, or the PRACH repetition number is equal to or less than the threshold value (or when the received quality is larger than the threshold value), terminal 200 may determine the transmission waveform of the Msg. 3 PUSCH to be DFT-s-OFDM while ignoring the configuration of msg3-transformPrecoder. On the other hand, for example, when the PRACH repetition level, the PRACH coverage enhancement level, or the PRACH repetition number is larger than the threshold value (or when the received quality is equal to or less than the threshold value), terminal 200 may determine the transmission waveform of the Msg. 3 PUSCH based on the configuration of msg3-transformPrecoder. As a result, when the PRACH repetition level, the PRACH coverage enhancement level, or the PRACH repetition number is equal to or less than the threshold value (or when the received quality is larger than the threshold value), the coverage of the Msg. 3 PUSCH can be expanded by the transmission waveform of DFT-s-OFDM.

### Embodiment 4

In the present embodiment, a description will be given of a case where a method for determining one set from a plurality of sets of configuration value candidates (e.g., configured set) for Repetition number and MCS for Msg.3 PUSCH repetition is allowed in the same manner as in Embodiments 2 and 3.

For example, in addition to the existing configuration value candidates for the Repetition number and the MCS index that can be indicated by UL grant (e.g., a legacy configured set), a scaling factor for calculating an additional configuration value candidate different from the legacy configured set may be configured in terminal 200.

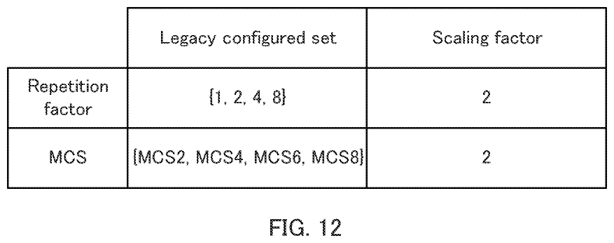

FIG. 12 is a diagram illustrating an example of the existing configuration value candidates for the Repetition number and MCS index that can be indicated by UL grant (legacy configured set) and a scaling factor for calculating additional configuration value candidates in the present embodiment.

Note that the scaling factor may be configured for both the Repetition number and the MCS index, or it may be configured for one of them and not for the other. Further, a scaling factor may be configured individually for each of the Repetition number and the MCS index (e.g., α_{Repetition} and α_{MCS}), or a common scaling factor may be configured for the Repetition number and the MCS index (e.g., α). Further, the scaling factor may be configured for terminal 200 by, for example, SIB, or may be a value defined in a standard (e.g., 2 or 4, and the like).

Further, in the present embodiment, terminal 200 may determine, for example, based on the method according to Embodiment 2 or Embodiment 3, whether to apply Repetition to PRACH, whether to request Msg.3 PUSCH repetition, and whether to use an additional configuration value candidate (or whether to apply a scaling factor) in the determination of Repetition number of Msg.3 PUSCH and the MCS.

Hereinafter, an operation example different from those in Embodiments 2 and 3 will be described in a case based on the methods according to Embodiments 2 and 3.

In a case based on the method according to Embodiment 2, in the processing of S201 illustrated in FIG. 9, terminal 200 may acquire information related to a scaling factor instead of information related to additional configuration value candidates (additional configured set). In addition, in the processing of S214 illustrated in FIG. 9, terminal 200 may acquire the Repetition number and the MCS index based on the existing configuration value candidates for the Repetition number and MCS index (legacy configured set), the scaling factor, and a value of the MCS field (e.g., 4 bits) by using the scaling factor instead of the information related to the additional configuration value candidates (additional configured set).

In addition, in a case based on the method according to Embodiment 3, in the processing of S301 illustrated in FIG. 11, terminal 200 may acquire information related to the scaling factor instead of the information related to additional configuration value candidates (additional configured set). In addition, in the processing of S313 illustrated in FIG. 11, terminal 200 may acquire the Repetition number and the MCS index based on the existing configuration value candidates for the Repetition number and MCS index (legacy configured set), the scaling factor, and a value of the MCS field (e.g., 4 bits) by using the scaling factor instead of the information related to the additional configuration value candidates (additional configured set).

In terminal 200, for example, the Repetition number is indicated using 2 bits of the MSB and the MCS index is indicated using 2 bits of the LSB of the 4-bit MCS field in the RAR UL grant. In this case, the candidates for the values of the Repetition number and the MCS index that can be indicated by the UL grant are four each.

For example, when terminal 200 determines to use the existing configuration value candidates for the Repetition number and MCS index (legacy configured set) for the determination of the Repetition number and the MCS, terminal 200 determines the Repetition number and the MCS index based on the indication of the MCS field of the UL grant and the existing configuration value candidates for the Repetition number and MCS index.

On the other hand, for example, when terminal 200 determines to use additional configuration value candidates in the determination of the Repetition number and the MCS, terminal 200 determines the Repetition number and the MCS index based on the indication of the MCS field of the UL grant, the existing configuration value candidates for the Repetition number and MCS index (legacy configured set), and the scaling factor.

For example, a value obtained by multiplying a scaling factor by the existing Repetition number candidate may be configured an additional Repetition number candidate. For example, in a case where the existing Repetition number candidates are {N₁, N₂, N₃, N₄} and the scaling factor is α, the additional Repetition number candidates may be configured to be {α×N₁, α×N₂, α×N₃, α×N₄}.

Further, for example, with respect to the MCS index, a value obtained by subtracting a scaling factor from the existing MCS index candidate may be configured as an additional MCS index candidate. For example, in a case where the MCS index candidates are {MCS₁, MCS₂, MCS₃, MCS₄} and the scaling factor is α, the additional MCS index candidates may be configured to be {MCS₁−α, MCS₂−α, MCS₃−α, MCS₄−α}.

In addition, in the present embodiment, for example, as in Embodiments 1 and 2, terminal 200 may determine the transmission waveform of the Msg. 3 PUSCH based on the configuration of the PRACH repetition (e.g., comparison of the received quality (e.g., RSRP) with the threshold value, rsrp-ThresholdPRACHrepetition), or as in Embodiment 3, terminal 200 may determine the transmission waveform of the Msg. 3 PUSCH based on the PRACH repetition level, the PRACH coverage enhancement level, the PRACH repetition number, or the received quality.

As described above, according to the present embodiment, terminal 200 performs the transmission control of Msg.3 PUSCH repetition based on a condition related to multiple PRACH transmission or PRACH repetition (e.g., a condition related to received quality or PRACH coverage level). Further, terminal 200 determines Repetition number and MCS index for Msg.3 PUSCH repetition transmission based on the legacy configured set and the scaling factor.

Thus, in an environment where multiple PRACH transmission or PRACH repetition is applied, terminal 200 can be indicated an appropriate value from the Repetition number and the MCS index configured for terminal 200 by SIB and can transmit Msg.3 PUSCH.

Further, for example, in an environment where the degree of coverage improvement requiring the application of multiple PRACH transmission or PRACH repetition is high (e.g., when the RSRP is equal to or less than the threshold value, rsrp-ThresholdPRACHrepetitionMoreLevel), terminal 200 can transmit Msg.3 PUSCH using an MCS that allows for a larger Repetition number or a lower coding rate.

Further, in the present embodiment, the overhead for the SIB can be reduced in comparison with Embodiment 2 or 3 by applying the scaling factor that makes indication of the additional configuration value candidates for the Repetition number and the MCS index (additional configured set) unnecessary.

### Variation of Embodiment 4

Note that, in Embodiment 4, with respect to the MCS index candidates, a value obtained by dividing a scaling factor by the existing MCS index candidate may be configured as an additional MCS index candidate. For example, in a case where the existing MCS index candidates are {MCS₁, MCS₂, MCS₃, MCS₄} and the scaling factor is a, the additional MCS index candidates may be configured as illustrated in Expression 1:

$$\{ ⌊ {MCS}_{1} / α ⌋ , ⌊ {MCS}_{2} / α ⌋ , ⌊ {MCS}_{3} / α ⌋ , ⌊ {MCS}_{4} / α ⌋ \} \qquad [ Expression 1 ]$$

$$or$$

$$\{ ⌈ {MCS}_{1} / α ⌉ , ⌈ {MCS}_{2} / α ⌉ , ⌈ {MCS}_{3} / α ⌉ , ⌈ {MCS}_{4} / α ⌉ \} .$$

Thus, it is possible to prevent the MCS index after scaling from becoming a negative value.

Further, for the MCS index candidates, instead of applying a scaling factor to the existing MCS index candidates, a scaling factor may be applied to a Target code rate (R) corresponding to the existing MCS index (see, e.g., NPL 7). For example, in a case where scaling factor α>1, the Target code rate after scaling may be calculated by Target code rate (R)/α corresponding to the existing MCS index. Further, in a case where the scaling factor α<1, the Target code rate after scaling may be calculated by Target code rate (R)×α corresponding to the existing MCS index.

Further, in Embodiment 4, when the MCS index after scaling (e.g., {MCS₁−α, MCS₂−α, MCS₃−α, MCS₄−α}) becomes a negative value, the scaling factor may be caused to act on the Target code rate (R) corresponding to the existing MCS index described above.

According to the variation of Embodiment 4, it is possible to implement a coding rate lower than a coding rate corresponding to an existing MCS index.

Further, in Embodiment 4, the MCS indexes {MCS₁−α, MCS₂−α, MCS₃−α, MCS₄−α} after scaling may be configured to be always 0 or more.

Further, for example, with respect to the Repetition number candidates, in a case where the Repetition number candidates are {N₁, N₂, N₃, N₄} and the scaling factor is α, the additional Repetition number candidates may be configured to values {N₁+α, N₂+α, N₃+α, N₄+α} obtained by adding the scaling factor to the existing Repetition number candidates.

The embodiments have been described thus far.

### [Configuration of Base Station]

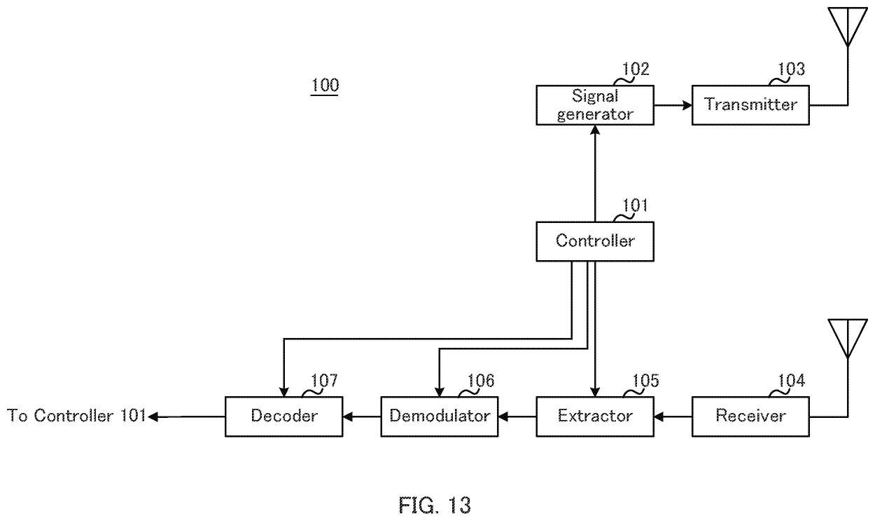

FIG. 13 is a block diagram illustrating a configuration example of base station 100 according to an example of the present disclosure. In FIG. 13, base station 100 includes controller 101, signal generator 102, transmitter 103, receiver 104, extractor 105, demodulator 106, and decoder 107.

At least one of controller 101, signal generator 102, extractor 105, demodulator 106, or decoder 107 illustrated in FIG. 13 may be included in the controller illustrated in FIG. 2. In addition, receiver 104 illustrated in FIG. 13 may be included in the receiver illustrated in FIG. 2.

Controller 101 determines information on PRACH transmission, for example, and outputs the determined information to signal generator 102. The information on PRACH transmission may include, for example, information on RACH resources and information on the threshold value for PRACH described above.

Further, controller 101 determines information on Msg.3 PUSCH transmission, for example, and outputs the determined information to signal generator 102. The information related to the Msg. 3 PUSCH transmission may include, for example, information related to the transmission waveform of the Msg. 3 PUSCH, and information related to a mutual relationship between the condition for terminal 200 to apply multiple PRACH transmission or PRACH repetition (e.g., the received quality) and the condition for terminal 200 to request the Msg. 3 PUSCH repetition (or to switch a method for determining the Repetition number or the MCS for the Msg. 3 PUSCH repetition) (e.g., a threshold value, a coverage level, or a scaling factor). Controller 101 may perform reception control of Msg.3 PUSCH repetition (e.g., configuration of transmission parameters such as Repetition number and MCS index) based on a condition for applying multiple PRACH transmission or PRACH repetition, for example.

Further, controller 101 may determine information on a radio resource for a downlink signal, for example.

Controller 101 outputs information on PRACH transmission, information on Msg.3 PUSCH transmission, and information on radio resources for a downlink signal to signal generator 102, extractor 105, demodulator 106, and decoder 107.

Note that, controller 101 may perform control related to uplink based on, for example, a detection result of PRACH inputted from decoder 107 or the received bit sequence after decoding of Msg.3 PUSCH.

Signal generator 102 generates, for example, a downlink signal such as a downlink data signal or a downlink control signal. For example, signal generator 102 generates a Synchronization Signal (SS)/Physical Broadcast Channel (PBCH) Block (SS/PBCH block) and an SIB bit sequence using the information inputted from controller 101. Signal generator 102 may apply encoding to the generated signal as necessary. The SIB bit sequence may include, for example, information related to the RACH resource inputted from controller 101, information related to the threshold value for the PRACH, information related to the transmission waveform of the Msg. 3 PUSCH, and information related to a mutual relationship between the condition for terminal 200 to apply multiple PRACH transmission or PRACH repetition and the condition for terminal 200 to request the Msg. 3 PUSCH repetition (or to switch a method for determining the Repetition number or the MCS for the Msg. 3 PUSCH repetition).

Signal generator 102, for example, modulates an encoded bit sequence of a signal including the information described above, generates a symbol sequence, and maps the symbol sequence to a radio resource based on information inputted from controller 101. Further, signal generator 102 outputs the signal after mapping to transmitter 103.

Transmitter 103 performs, for example, transmission waveform generation processing such as orthogonal frequency division multiplexing (OFDM) on the signal inputted from signal generator 102. Further, in case of OFDM transmission with a cyclic prefix (CP) added, for example, transmitter 103 performs inverse fast Fourier transform (IFFT) processing on the signal and adds a CP to the signal after the IFFT. Further, for example, transmitter 103 performs RF processing such as D/A conversion or up-conversion on the signal, and transmits a radio signal to terminal 200 via an antenna.

Receiver 104 performs RF processing, such as down-conversion or A/D conversion on the uplink signal received from terminal 200 via an antenna, for example. Further, in the case of OFDM transmission, receiver 104 performs, for example, Fast Fourier Transform (FFT) processing on the received signal and outputs the obtained frequency domain signal to extractor 105.

Extractor 105 extracts, for example, a radio resource portion in which PRACH or Msg.3 PUSCH is transmitted from the received signal inputted from receiver 104, based on the information inputted from controller 101, and outputs the extracted radio resource portion to demodulator 106.

Demodulator 106 demodulates the signal inputted from extractor 105, based on the information inputted from controller 101, for example. Demodulator 106 outputs, for example, the demodulation result to decoder 107.

Decoder 107 performs, for example, detection of PRACH or error correction decoding of Msg.3 PUSCH based on the information inputted from controller 101 and the demodulation result inputted from demodulator 106, and obtains the detection result of PRACH or the received bit sequence after decoding of Msg.3 PUSCH. Decoder 107 may output the detection result of PRACH or the received bit sequence after decoding Msg.3 PUSCH to controller 101.

### [Configuration of Terminal]

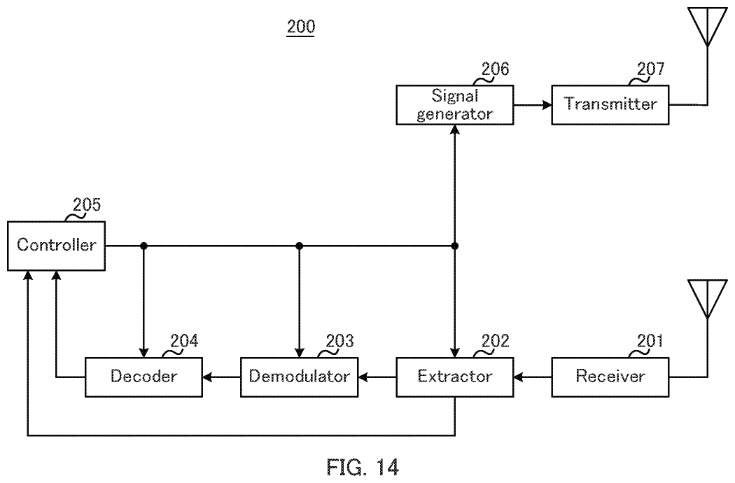

FIG. 14 is a block diagram illustrating a configuration example of terminal 200 according to an example of the present disclosure. For example, in FIG. 14, terminal 200 includes receiver 201, extractor 202, demodulator 203, decoder 204, controller 205, signal generator 206, and transmitter 207.

At least one of extractor 202, demodulator 203, decoder 204, controller 205, and signal generator 206 illustrated in FIG. 14 may be included in the controller illustrated in FIG. 3. In addition, transmitter 207 illustrated in FIG. 14 may be included in the transmitter illustrated in FIG. 3.

Receiver 201 receives, for example, a downlink signal (e.g., a data signal or a downlink control signal) from base station 100 via an antenna, performs RF processing, such as down-conversion or A/D conversion on the radio received signal, and obtains a received signal (baseband signal). Further, when receiver 201 receives an OFDM signal, receiver 201 performs FFT processing on the received signal and converts the received signal into the frequency domain. Receiver 201 outputs the received signal to extractor 202.

Extractor 202, for example, extracts a radio resource portion that may include an SS/PBCH block and an SIB from the received signal inputted from receiver 201, based on information on a radio resource of a downlink signal inputted from controller 205, and outputs the radio resource portion to demodulator 203 and controller 205.

Demodulator 203, for example, demodulates the signal inputted from extractor 202, based on information inputted from controller 205, and outputs the demodulation result to decoder 204.

Decoder 204 obtains information included in PBCH or SIB using the demodulation result inputted from demodulator 203, based on information inputted from controller 205, for example. Decoder 204 outputs the obtained control information to controller 205.

Controller 205 measures the received quality (e.g., RSRP) using the received signal inputted from extractor 202. Further, for example, controller 205 may determine the PRACH transmission method (e.g., the presence or absence of application of Repetition) by using the measured received quality (e.g., RSRP) and the control information inputted from decoder 204, according to the method described above. In addition, controller 205 may determine a transmission method for the Msg. 3 PUSCH (e.g., a transmission waveform, the presence or absence of application of Repetition, or a method for determining Repetition number and MCS) by the above-described method by using the measured received quality (e.g., RSRP). Controller 205 outputs the determined information to signal generator 206.

Further, for example, controller 205 determines information on a downlink signal (e.g., a radio resource or MCS) using the control information inputted from decoder 204, and outputs the determined information to extractor 202, demodulator 203, and decoder 204.

Signal generator 206 generates a PRACH signal or Msg.3 PUSCH based on the information inputted from controller 205. Signal generator 206 maps the generated PRACH signal or Msg.3 PUSCH to the radio resource indicated by controller 205 and outputs the mapped signal to transmitter 207.

Transmitter 207 generates a transmission signal waveform, for example, OFDM, for the signal inputted from signal generator 206. Further, in case of OFDM transmission using a CP, transmitter 207 performs IFFT processing on the signal and adds a CP to the signal after the IFFT. Alternatively, when transmitter 207 generates a single carrier waveform, a Discrete Fourier Transform (DFT) section may be added, for example, to a stage after a modulation processor (not illustrated) or to a stage before a signal assigner (not illustrated) (not illustrated). Further, for example, transmitter 207 performs RF processing, such as D/A conversion and up-conversion on the transmission signal and transmits a radio signal to base station 100 via an antenna.

The embodiments according to non-limiting examples of the present disclosure have been each described, thus far.

### (Variation)

The threshold value for PRACH in the above-described embodiment may be configured as a relative value (or difference) with respect to the threshold value for the existing Msg.3 (e.g., rsrp-ThresholdMsg3). The use of the relative value make it possible to reduce the overhead associated with the indication of the threshold value for PRACH.

Further, the threshold value (e.g., rsrp-ThresholdPRACHrepetitionMoreLevel) for determining whether to use an additional configuration value candidate in Embodiment 2 may also be configured as a relative value with respect to the existing threshold value for Msg.3 (e.g., rsrp-ThresholdMsg3).

For example, terminal 200 measures the received quality (RSRP, RSRQ, or SINR), and determines the Repetition number and the MCS index based on the indication of the MCS field of the UL grant and the existing configuration value candidates for Repetition number and MCS index in a case where the difference (relative value) between the received quality and the threshold value for Msg.3 (e.g., rsrp-ThresholdMsg3) is smaller than a threshold value (e.g., Y described later). On the other hand, in a case where the difference (relative value) between the received quality and the threshold value for Msg.3 is equal to or greater than the threshold value, terminal 200 determines the Repetition number and the MCS index based on the indication of the MCS field of the UL grant and the additional configuration value candidates described above.

Here, the threshold value for the relative value (e.g., Y described later) for determining whether to use an additional configuration value candidate in the determination of the Repetition number and MCS for the Msg.3 PUSCH repetition is configured to be larger than a threshold value for the relative value (e.g., X described later) for PRACH.

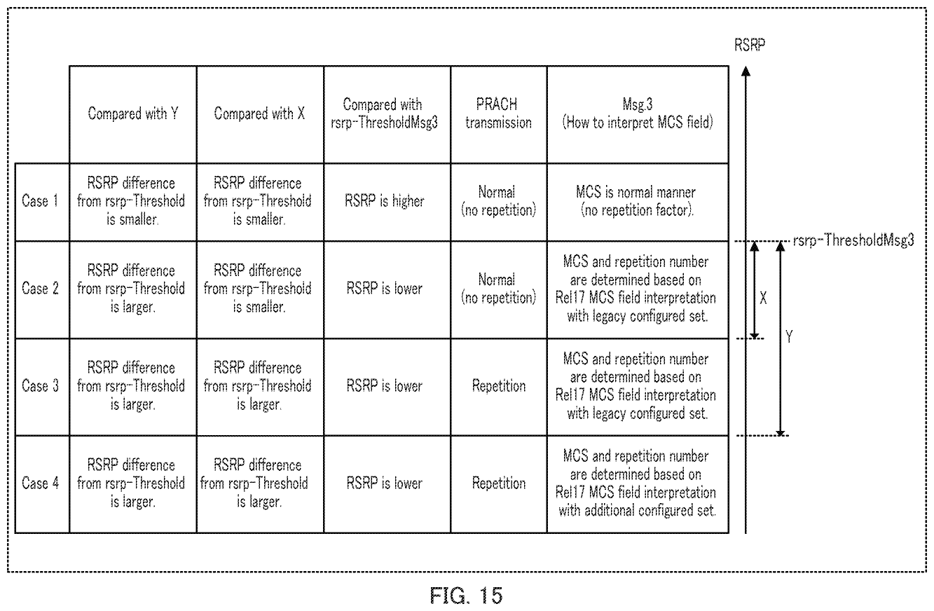

FIG. 15 is a diagram illustrating an example of a mutual relationship between a relative value of received quality for applying multiple PRACH transmission or PRACH repetition, received quality for terminal 200 to request the Msg. 3 PUSCH repetition, and a method for determining the Repetition number and the MCS for the Msg. 3 PUSCH repetition from the received quality requesting Msg. 3 PUSCH repetition (e.g., a threshold value, rsrp-ThresholdMsg3) according to the variation.

As illustrated in FIG. 15, when the difference (relative value) between the received quality and the threshold value, rsrp-ThresholdMsg3 for Msg. 3 is smaller than the threshold value X (case 2), multiple PRACH transmission or PRACH repetition is not applied, the Msg. 3 PUSCH repetition is requested, and the Repetition number and the MCS for the Msg. 3 PUSCH repetition are determined based on the existing configuration value candidates (legacy configured set).

In addition, as illustrated in FIG. 15, when the difference (relative value) between the received quality and the threshold value, rsrp-ThresholdMsg3 for Msg. 3 is equal to or larger than the threshold value X and smaller than the threshold value Y (case 3), multiple PRACH transmission or PRACH repetition is applied, the Msg. 3 PUSCH repetition is requested, and the Repetition number and the MCS for the Msg. 3 PUSCH repetition are determined based on the existing configuration value candidates (legacy configured set).

In addition, as illustrated in FIG. 15, when the difference (relative value) between the received quality and the threshold value, rsrp-ThresholdMsg3 for Msg. 3 is equal to or larger than the threshold value Y (case 4), multiple PRACH transmission or PRACH repetition is applied, the Msg. 3 PUSCH repetition is requested, and the Repetition number and the MCS for the Msg. 3 PUSCH repetition are determined based on the additional configuration value candidates (additional configured set).

### Other Embodiments

(1) In each of the embodiments described above, the operation related to the initial transmission of Msg.3 PUSCH has been focused on. In other words, the operation examples of each embodiment described above are operation examples related to the determination of the Repetition number and the MCS for Msg.3 PUSCH scheduled by RAR UL grants. On the other hand, each of the embodiments described above can be applied to retransmission of Msg.3 PUSCH. For example, each of the embodiments described above can be applied to the determination of Repetition number and the MCS for Msg.3 PUSCH scheduled by DCI format 0-0 scrambled with TC-RNTI.

The MCS field of DCI format 0-0 scrambled by TC-RNTI is composed of 5 bits. In the existing determination method for Repetition number and MCS index, the Repetition number is indicated using 2 bits of the MSB of the 5-bit MCS field in DCI format 0-0 scrambled by TC-RNTI, and the MCS index is indicated using 3 bits of the LSB of the 5-bit MCS field. At this time, the configuration value candidates for each of the Repetition number and the MCS index that can be indicated by DCI (e.g., 2 bits) are four and these may be configured in terminal 200 by SIB.

At this time, Repetition number and the MCS index of the Msg.3 PUSCH scheduled by DCI format 0-0 scrambled with TC-RNTI may be determined based on an additional configuration value candidate or a scaling factor described above. As a condition for using the determination method for the Repetition number and the MCS by an additional configuration value candidate or the scaling factor, the method for each embodiment described above may be applied.

Further, the additional configuration value candidate or the scaling factor may be the same value or different value between the initial retransmission (e.g., Msg.3 PUSCH scheduled by RAR UL grant) and the retransmission (e.g., Msg.3 PUSCH scheduled by DCI format 0-0 scrambled by TC-RNTI).

(2) In each of the embodiments described above, a method for indicating Repetition number and MCS index by reusing the MCS field of DCI format 0-0 scrambled with the UL grant of RAR or TC-RNTI has been focused on. However, for example, the indication method for the Repetition number is not limited to a method for reusing the MCS field.

For example, Repetition number may be indicated by a Time Domain Resource Assignment (TDRA) table for Msg.3 PUSCH repetition, which includes Repetition number in addition to the K2 offset and SLIV.

Further, another field may be reused instead of the MCS field. For example, Repetition number may be indicated by reusing the Transmit Power Control (TPC) field.

Further, in DCI format 0-0 scrambled with TC-RNTI, the HARQ process number field may be reused to indicate Repetition number.

In these indication methods for Repetition number as well, the Repetition number may be determined by the additional configuration value candidates described above.

(3) In the above-described embodiment, a case has been described in which terminal 200 ignores the configuration of msg3-transformPrecoder and determines the transmission waveform of the Msg. 3 PUSCH to be DFT-s-OFDM when terminal 200 transmits the PRACH with application of multiple PRACH transmission or PRACH repetition, but a method for determining the transmission waveform of the Msg. 3 PUSCH is not limited to the above-described method, and the transmission waveform of the Msg. 3 PUSCH may be determined by, for example, an indication from base station 100.

For example, in the initial transmission of Msg. 3 PUSCH, the transmission waveform of the Msg. 3 PUSCH may be indicated by RAR UL grant or DCI format 0-0 using CRC scrambled by RA-RNTI. For example, any one of the following methods (options) may be applied as an indication method for the transmission waveform in the initial transmission of the Msg. 3 PUSCH.

### <Option 1>

In Option 1, the transmission waveform of PUSCH is determined based on an index indicated to terminal 200 by the Time domain resource assignment (TDRA) field.

Terminal 200 determines the time-domain resource assignment of Msg. 3 PUSCH transmission and the transmission waveform of Msg. 3 PUSCH based on information of the TDRA field. For example, terminal 200 determines a time-domain assignment resource candidate (e.g., a combination of K2, S, L, and a transmission waveform) in association with the index based on the index indicated by the TDRA field. The association between the value of the index of the TDRA and the transmission waveform of the PUSCH (e.g., the transmission waveform when index n is indicated) may be configured by RRC or may be determined in advance by the standard.

### <Option 2>

In Option 2, the transmission waveform of Msg. 3 PUSCH is determined based on an index indicated to terminal 200 by the MCS field.

Terminal 200 determines the number of modulation values Qₘ of PUSCH transmission, the target coding rate R, and the transmission waveform of Msg. 3 PUSCH, based on the information of the MCS. For example, terminal 200 determines, based on an index I_{MCS} indicated by the MCS field, the transmission waveform associated with this index. The association between the value of I_{MCS} and the transmission waveform of PUSCH (e.g., the transmission waveform in a case where I_{MCS}=n is indicated) may be configured by RRC or may be determined in advance by the standard. In addition, in the association set by the RRC, for example, the association between each I_{MCS} and the transmission waveform may be indicated, or a threshold value (e.g., “waveform-MCS”) of an MCS number for switching the transmission waveform may be indicated.

### <Option 3>

In Option 3, terminal 200 determines the transmission waveform of Msg. 3 PUSCH based on information indicated to terminal 200 by a Reserved bit of the RAR UL grant (e.g., waveform indicator).

### <Option 4>

In Option 4, terminal 200 determines the transmission waveform of Msg. 3 PUSCH based on information indicated to terminal 200 by a Reserved bit of the DCI format 0-0 using the CRC scrambled by the RA-RNTI (e.g., waveform indicator).

An example of the indication method for the transmission waveform in the initial transmission of Msg. 3 PUSCH has been described above.

In addition, in the retransmission of Msg. 3 PUSCH, the transmission waveform of Msg. 3 PUSCH may be indicated by the DCI format 0-0 using the CRC scrambled by TC-RNTI. Any one of the following methods (options) may be applied as an indication method for a transmission waveform in the retransmission of Msg. 3 PUSCH.

### <Option 1>

In Option 1, the transmission waveform of PUSCH is determined based on an index indicated to terminal 200 by the TDRA field.

Terminal 200 determines the time-domain resource assignment of Msg. 3 PUSCH transmission and the transmission waveform of Msg. 3 PUSCH based on information of the TDRA field. For example, terminal 200 determines, based on an index indicated by the TDRA field, a time-domain assignment resource candidate (e.g., a combination of K2, S, L, and a transmission waveform) associated with this index. The association between the value of the index of the TDRA and the transmission waveform of PUSCH (e.g., the transmission waveform in a case where an index n is indicated) may be configured by RRC or may be determined in advance by the standard.

### <Option 2>

In Option 2, the transmission waveform of Msg. 3 PUSCH is determined based on an index indicated to terminal 200 by the MCS field.

Terminal 200 determines the number of modulation values Qₘ of PUSCH transmission, the target coding rate R, and the transmission waveform of Msg. 3 PUSCH based on the information of the MCS. For example, terminal 200 determines, based on an index I_{MCS} indicated by the MCS field, the transmission waveform associated with this index. The association between the value of I_{MCS} and the transmission waveform of the PUSCH (e.g., the transmission waveform in a case where I_{MCS}=n is indicated) may be configured by RRC or may be determined in advance by the standard. In addition, in the association configured by RRC, for example, the association between each I_{MCS} and the transmission waveform may be indicated, or a threshold value for an MCS number for switching the transmission waveform (e.g., “waveform-MCS”) may be indicated.

### <Option 3>

In Option 3, terminal 200 determines the transmission waveform of Msg. 3 PUSCH by replacing one or some of bit fields in the TPC field with a waveform indicator.

### <Option 4>

In Option 4, terminal 200 determines the transmission waveform of Msg. 3 PUSCH by replacing one or some of bit fields in the HARQ process number field with a waveform indicator.

### <Option 5>

In Option 5, terminal 200 determines the transmission waveform of Msg. 3 PUSCH based on information indicated to terminal 200 by a Reserved bit of DCI format 0-0 using CRC scrambled by TC-RNTI (e.g., waveform indicator).

(4) In NR Rel. 18, repetition transmission of PUCCH that transmits HARQ-ACK for Msg. 4 PDSCH has been discussed. The Msg.3 PUSCH described in each of the embodiments above may be replaced with PUCCH, and each of the embodiments may be applied to a method for determining Repetition number of PUCCH for transmitting HARQ-ACK for Msg.4 PDSCH.

In addition to the above-described embodiments, each embodiment may be applied to the method for determining Repetition number of the PUCCH that transmits HARQ-ACK for Msg. 4 PDSCH by replacing Msg. 3 PUSCH with PUCCH. For example, the method for determining the Repetition number in each embodiment described above may be simultaneously applied to both Msg. 3 PUSCH and the PUCCH that transmits HARQ-ACK for the Msg. 4 PDSCH. Further, different embodiments may be applied to PUCCHs for transmitting HARQ-ACKs for Msg.3 PUSCH and Msg.4 PDSCH, respectively.

In addition, in the method for determining Repetition number of the PUCCH that transmits HARQ-ACK for Msg. 4 PDSCH, a relative value from the Repetition number of Msg. 3 PUSCH may be indicated by a DCI field that assigns the Msg. 4 PDSCH. For example, the relative value indicated by the DCI field may be ½ or ¼, or may be another value. In addition, a set of relative values indicated by the DCI field may be configured by SIB. For example, the set of the relative values may be {½, ¼} or {1, ½}, or may be other values.

In addition, for example, in a case where each embodiment is applied to the method for determining Repetition number of the PUCCH that transmits HARQ-ACK for Msg. 4 PDSCH by replacing the Msg. 3 PUSCH described in each embodiment described above with PUCCH, terminal 200 that has applied PRACH repetition may operate to request Msg. 4 PUCCH repetition.

In addition, it is also assumed that PRACH and the PUCCH that transmits HARQ-ACK for Msg. 4 PDSCH are channels for which coverage is the same, or the coverage improvement is desired more for PRACH. Accordingly, the same parameter may be applied to a threshold value for the presence or absence of the application of Repetition of PUCCH repetition for transmitting HARQ-ACK for PRACH repetition and Msg.4 PDSCH. Further, the threshold value for PRACH may be configured to a value larger than the threshold value for PUCCH for transmitting HARQ-ACK for Msg.4 PDSCH.

(5) Different embodiments may be applied to the initial transmission and retransmission of Msg. 3 for the determination method for the transmission waveform. For example, the transmission waveform in the initial transmission of Msg. 3 may be determined by the presence or absence of the PRACH repetition or a PRACH repetition level by the methods of Embodiments 1 to 3, and the transmission waveform in the retransmission of Msg. 3 may be determined by dynamic indication from base station 100 by the method of the other embodiment (Embodiment 3) described above.

In addition, for example, the transmission waveform in the initial transmission of Msg. 3 may be determined by dynamic indication from base station 100 by the method of the other embodiment (Embodiment 3) described above, and the transmission waveform in the retransmission of Msg. 3 may be determined by the presence or absence of PRACH repetition or a PRACH repetition level by the methods of Embodiments 1 to 3.

In addition, for example, the transmission waveform in the initial transmission of Msg. 3 may be determined by the presence or absence of PRACH repetition or a PRACH repetition level by the methods of Embodiments 1 to 3, or may be determined by dynamic indication from base station 100 by the method of the other embodiment (Embodiment 3) described above, and the transmission waveform in the retransmission of Msg. 3 may be determined to be the same transmission waveform as that in the initial transmission.

(6) In each of the above-described embodiments, a description has been given of the relationship between the PRACH repetition (e.g., multiple PRACH transmission or PRACH repetition) and both the transmission waveforms of Msg. 3 PUSCH repetition and Msg. 3 PUSCH, but the present disclosure is not limited to this. For example, an example of the present disclosure may be applied to a relationship between the PRACH repetition (e.g., multiple PRACH transmission or PRACH repetition) and the transmission waveform of the Msg. 3 PUSCH. For example, the transmission waveform of Msg. 3 PUSCH may be determined based on the presence or absence of PRACH repetition or a PRACH repetition level, and the Msg. 3 PUSCH repetition may not be determined.

(7) In each of the above-described embodiments, the number of bits (e.g., 2-MSB) of the MCS field reused to indicate the Repetition number is exemplary, and another number of bits may be reused. For example, the number of bits of the MCS field is not limited to 4 bits or 5 bits and may be another number of bits, and the number of bits to be reused for indicating the Repetition number in the MCS field is not limited to 2 bits and may be 1 bit or 3 bits or more. Further, the bit position reused to indicate the Repetition number in the MCS field is not limited to the MSB, and may be another bit position.

Further, RRC parameter names (e.g., rsrp-ThresholdMsg3, rsrp-ThresholdPRACHrepetition, rsrp-ThresholdPRACHrepetitionMoreLevel, level-prach-For-msg3repetition, and the like) in each of the embodiments described above are examples, and other parameter names may be used.

In addition, the Repetition number (e.g., 1, 2, 4, 8, 12, and 16) in each of the above-described embodiments is an example, and another number of repetitions may be configured.

In addition, the transmission waveforms of the signals used in each of the above-described embodiments are not limited to DFT-s-OFDM and CP-OFDM, and another transmission waveform may be used.

(8) In each of the above-described embodiments, the transmission of PRACH, PUSCH, or PUCCH has been described as uplink transmission, but the channel used for uplink transmission is not limited to PRACH, PUSCH, and PUCCH and may be another channel. Further, the type of information to be transmitted may be either data or an uplink control signal. Further, an exemplary embodiment of the present disclosure is not limited to the uplink transmission, but may be applied to downlink transmission or sidelink transmission.

Further, in the present disclosure, Repetition may also be referred to as, for example, slot aggregation, slot bundling, TTI aggregation, or TTI bundling.

The present disclosure may be applied to, for example, communication between terminals, such as sidelink communication.

Further, in the present disclosure, a downlink control channel, a downlink data channel, an uplink control channel, and an uplink data channel are not limited to PDCCH, PDSCH, PUCCH, and PUSCH, respectively, and may be control channels having other names.

Further, in the present disclosure, the RRC signaling is assumed for the higher layer signaling, but the signaling may be replaced with Medium Access Control (MAC) signaling and indication by a DCI that is physical layer signaling.

### (Complement)

Information indicating whether terminal 200 supports the functions, operations, or pieces of processing that have been indicated in the above-mentioned embodiments and complements may be transmitted (or indicated) from terminal 200 to base station 100, as capability information or a capability parameter for terminal 200, for example.

The capability information may include information elements (IEs) that individually indicate whether terminal 200 supports at least one of the functions, operations, or pieces of processing that have been described in the above-mentioned embodiments, variations, and complements. Alternatively, the capability information may include information elements that indicate whether terminal 200 supports a combination of any two or more of the functions, operations, or pieces of processing that have been described in the above-mentioned embodiments, variations, and complements.

Base station 100 may determine (or decide or assume), for example, based on the capability information received from terminal 200, the functions, operations, or processes that are supported (or not supported) by terminal 200, which is a transmission source of the capability information. Base station 100 may execute operations, processes, or control in accordance with a determination result based on the capability information. For example, base station 100 may control uplink-related processing based on the capability information received from terminal 200.

Note that, in a case where terminal 200 does not entirely support the functions, operations, or pieces of processing described in the above-mentioned embodiments, variations, and complements, such an unsupported part of the functions, operations, or processes may be interpreted as a limitation in terminal 200. For example, information or a request relating to such limitation may be indicated to base station 100.

The information on the capability or the limitation of terminal 200 may be defined by standards or may be implicitly indicated to base station 100 in association with information known in base station 100 or information to be transmitted to base station 100, for example.

The embodiments, the variations, and the complements according to a non-limiting and exemplary embodiment of the present disclosure have been each described, thus far.

### (Control Signals)

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sidelink control information (SCI) or the 2nd stage SCI.

### (Base Station)

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, the base station may be replaced with a terminal. The base station may be a relay apparatus that relays communication between a higher node and a terminal. The base station may be a roadside unit as well.

### (Uplink/Downlink/Sidelink)

The present disclosure may be applied to any of uplink, downlink and sidelink. The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### (Data Channels/Control Channels)

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### (Reference Signals)

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### (Time Intervals)

In the present disclosure, time resource units are not limited to one or a combination of slots and symbols, and may be time resource units, such as frames, superframes, subframes, slots, time slots, subslots, minislots, or time resource units, such as symbols, Orthogonal Frequency Division Multiplexing (OFDM) symbols, Single Carrier-Frequency Division Multiple Access (SC-FDMA) symbols, or other time resource units. The number of symbols included in one slot is not limited to any number of symbols exemplified in the embodiment(s) described above, and may be other numbers of symbols.

### (Frequency Bands)

The present disclosure may be applied to any of a licensed band and an unlicensed band.

### (Communication)

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large latency compared with a symbol length or a slot length, such as an ultra-wideband transmission network.

### (Antenna Ports)

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

### <5G NR System Architecture and Protocol Stack>

3GPP has been working on the next release for the 5th generation cellular technology (simply called “5G”), including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

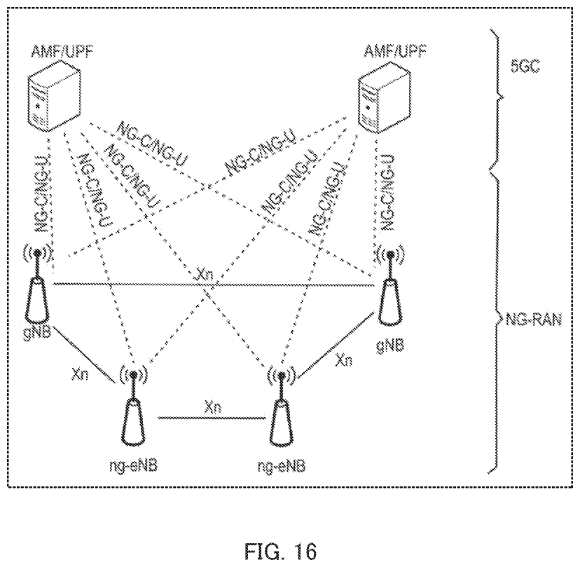

For example, the overall system architecture assumes an NG-RAN (Next Generation-Radio Access Network) that includes gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 16 (see e.g., 3GPP TS 38.300 v15.6.0, section 4).

The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of TS 38.300) and MAC (Medium Access Control, see clause 6.2 of TS 38.300) sublayers, which are terminated in the gNB on the network side. Additionally, a new Access Stratum (AS) sublayer (SDAP, Service Data Adaptation Protocol) is introduced above the PDCP (see e.g., clause 6.5 of 3GPPTS 38.300). A control plane protocol stack is also defined for NR (see for instance TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates on the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 kHz, 30 kHz, and 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and each carrier, resource grids of subcarriers and OFDM symbols are defined respectively for uplink and downlink. Each element in the resource grids is called a resource element and is identified based on the frequency index in the frequency domain and the symbol position in the time domain (see 3GPP TS 38.211 v15.6.0).

<Functional Split between NG-RAN and 5GC in 5G NR>

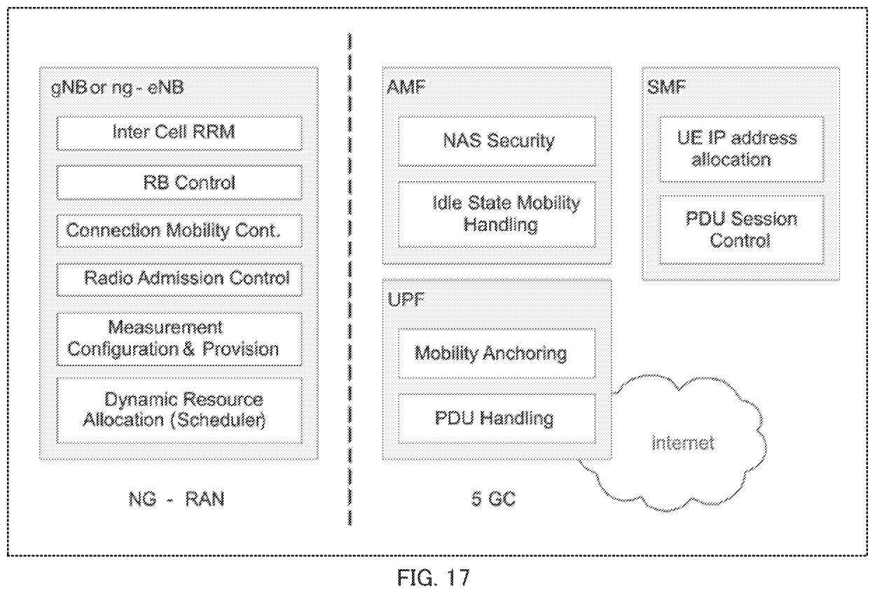

FIG. 17 illustrates the functional split between the NG-RAN and the 5GC. A logical node of the NG-RAN is gNB or ng-eNB. The 5GC includes logical nodes AMF, UPF, and SMF.

For example, gNB and ng-eNB hosts the following main functions:
Radio Resource Management functions such as Radio Bearer Control, Radio Admission Control, Connection Mobility Control, and dynamic allocation (scheduling) of both uplink and downlink resources to a UE;
IP header compression, encryption, and integrity protection of data;
Selection of an AMF during UE attachment in such a case when no routing to an AMF can be determined from the information provided by the UE;
Routing user plane data towards the UPF;
Routing control plane information towards the AMF;
Connection setup and release;
Scheduling and transmission of paging messages;
Scheduling and transmission of system broadcast information (originated from the AMF or an operation management maintenance function (OAM: Operation, Admission, Maintenance));
Measurement and measurement reporting configuration for mobility and scheduling;
Transport level packet marking in the uplink;
Session management;
Support of network slicing;
QoS flow management and mapping to data radio bearers;
Support of UEs in the RRC_INACTIVE state;
Distribution function for NAS messages;
Radio access network sharing;
Dual connectivity; and
Tight interworking between NR and E-UTRA.

The Access and Mobility Management Function (AMF) hosts the following main functions:
Function of Non-Access Stratum (NAS) signaling termination;
NAS signaling security;
Access Stratum (AS) security control;
Inter-Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

In addition, the User Plane Function (UPF) hosts the following main functions:
Anchor Point for intra-/inter-RAT mobility (when applicable);
External Protocol Data Unit (PDU) session point for interconnection to a data network;
Packet routing and forwarding;
Packet inspection and a user plane part of Policy rule enforcement;
Traffic usage reporting;
Uplink classifier to support routing traffic flows to a data network;
Branching point to support multi-homed PDU session;
QoS handling for user plane (e.g., packet filtering, gating, UL/DL rate enforcement);
Uplink traffic verification (SDF to QoS flow mapping); and
Function of downlink packet buffering and downlink data notification triggering.

Finally, the Session Management Function (SMF) hosts the following main functions:
Session management;
UE IP address allocation and management;
Selection and control of UPF;
Configuration function for traffic steering at the User Plane Function (UPF) to route traffic to a proper destination;
Control part of policy enforcement and QoS; and
Downlink data notification.

### <RRC Connection Setup and Reconfiguration Procedure>

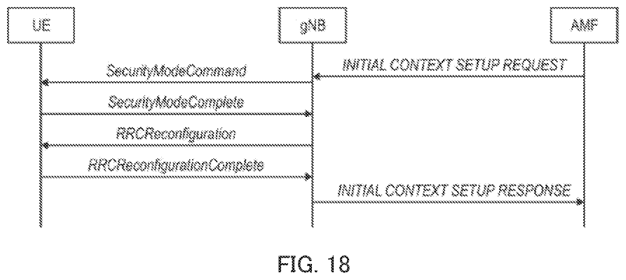

FIG. 18 illustrates some interactions between a UE, gNB, and AMF (a 5GC Entity) performed in the context of a transition of the UE from RRC_IDLE to RRC_CONNECTED for the NAS part (see TS 38 300 v15.6.0).

The RRC is higher layer signaling (protocol) used to configure the UE and gNB. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a Security ModeCommand message and by the UE responding to the gNB with the SecurityModeComplete message. Afterwards, the gNB performs the reconfiguration to setup the Signaling Radio Bearer 2 (SRB2) and Data Radio Bearer(s) (DRB(s)) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB indicates the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### <Usage Scenarios of IMT for 2020 and Beyond>

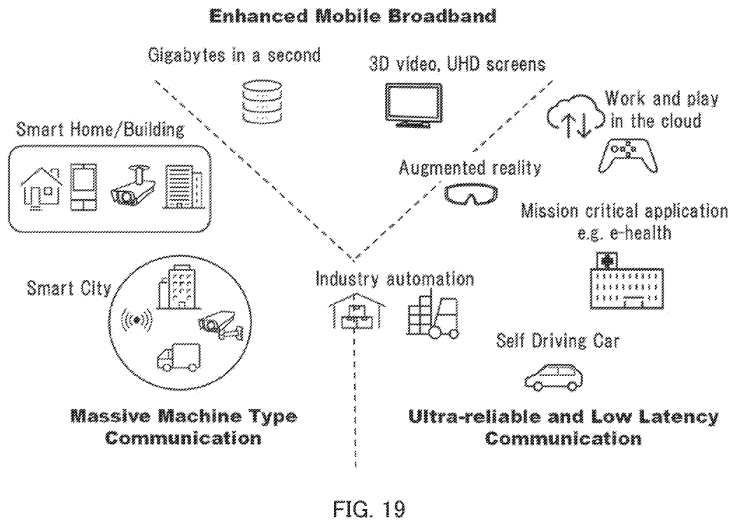

FIG. 19 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 19 illustrates some examples of envisioned usage scenarios for IMT for 2020 and beyond (see e.g., ITU-R M.2083 FIG. 2).

The URLLC use case has sequenceent requirements for capabilities such as throughput, latency and availability. The URLLC use case has been envisioned as one of the enablers for future vertical applications such as wireless control of industrial manufacturing or production processes, remote medical surgery, distribution automation in a smart grid, transportation safety. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a block error rate (BLER) of 1E−5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E−5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability improvement in general, regardless of particular communication scenarios.

For NR URLLC, further use cases with tighter requirements have been envisioned such as factory automation, transport industry and electrical power distribution. The tighter requirements are higher reliability (up to 10⁻⁶ level), higher availability, packet sizes of up to 256 bytes, time synchronization up to the extent of a few μs (where the value can be one or a few us depending on frequency range and short latency on the order of 0.5 to 1 ms (in particular a target user plane latency of 0.5 ms), depending on the use cases).

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### <QoS Control>

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU sessions. For each UE, the NG-RAN establishes at least one Data Radio Bearer (DRB) together with the PDU session, e.g., as illustrated above with reference to FIG. 18. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

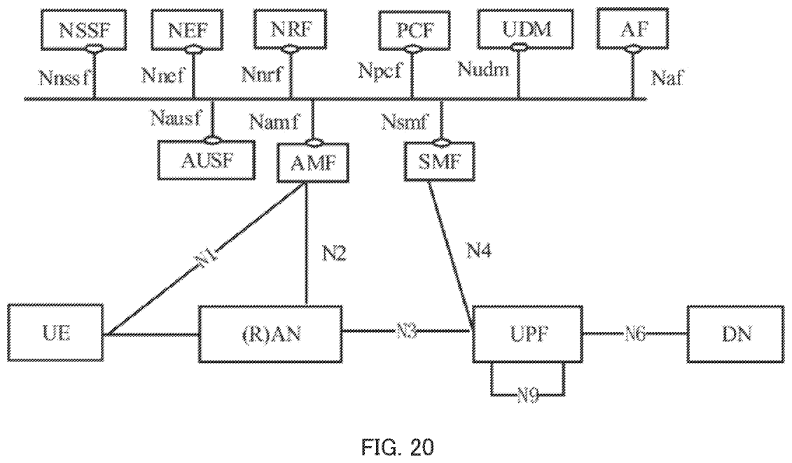

FIG. 20 illustrates a 5G NR non-roaming reference architecture (see TS 23.501 v16.1.0, section 4.23). An Application Function (AF) (e.g., an external application server hosting 5G services, exemplarily described in FIG. 19) interacts with the 3GPP Core Network in order to provide services. For example, to support application influencing on traffic routing, the interaction includes accessing Network Exposure Function (NEF) or interacting with the policy framework for policy control (e.g., QoS control) (see Policy Control Function, PCF). Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 20 illustrates further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN, e.g., operator services, Internet access, or third party services). All of or a part of the core network functions and the application services may be deployed and running on cloud computing environments.

In the present disclosure, thus, an application server (e.g., AF of the 5G architecture), is provided that includes: a transmitter, which in operation, transmits a request containing a QoS requirement for at least one of URLLC, eMMB and mMTC services to at least one of functions (such as NEF, AMF, SMF, PCF, and UPF) of the 5GC to establish a PDU session including a radio bearer between a gNodeB and a UE in accordance with the QoS requirement; and control circuitry, which, in operation, performs the services using the established PDU session.

In the description of the present disclosure, the term ending with a suffix, such as “-er” “-or” or “-ar” may be interchangeably replaced with another term, such as “circuit (circuitry),” “device,” “unit,” or “module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, an FPGA (Field Programmable Gate Array) that can be programmed after the manufacture of the LSI or a reconfigurable processor in which the connections and the configurations of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smartphone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

A terminal according to an embodiment of the present disclosure includes: control circuitry, which, in operation, configures, based on a condition related to repetition transmission of a first signal, a transmission waveform of a second signal; and transmission circuitry, which, in operation, transmits the second signal using the transmission waveform.

In the terminal according to the embodiment of the present disclosure, the control circuitry configures the transmission waveform to be Discrete Fourier Transform-spread-Orthogonal Frequency Division Multiplexing (DFT-s-OFDM) when the repetition transmission of the first signal is performed.

The terminal according to the embodiment of the present disclosure further includes reception circuitry, which, in operation, receives configuration information related to the transmission waveform, in which, the control circuitry configures, when the repetition transmission of the first signal is performed, the transmission waveform to be Discrete Fourier Transform-spread-Orthogonal Frequency Division Multiplexing (DFT-s-OFDM) while ignoring the configuration information, and the control circuitry configures, when the repetition transmission of the first signal is not performed, the transmission waveform based on the configuration information.

In the terminal according to the embodiment of the present disclosure, the control circuitry determines the transmission waveform based on the condition related to at least one of a level of the repetition transmission of the first signal, a coverage enhancement level of the repetition transmission of the first signal, a number of repetition transmissions of the first signal, and/or received quality for performing the repetition transmission of the first signal.

In the terminal according to the embodiment of the present disclosure, the control circuitry controls repetition transmission of the second signal based on the condition.

In the terminal according to the embodiment of the present disclosure, the condition is a condition related to received quality for performing the repetition transmission of the first signal, and the control circuitry determines a request for the repetition transmission of the second signal in a case where the received quality is equal to or less than a threshold value.

In the terminal according to the embodiment of the present disclosure, the control circuitry determines, regardless of the presence or absence of the repetition transmission of the first signal, when the request for the repetition transmission of the second signal is made, a number of repetition transmissions of the second signal based on one or some of bits of a Modulation and Coding Scheme (MCS) field included in assignment information for the second signal, and determines an MCS index based on a remaining bit of the MCS field.

In the terminal according to the embodiment of the present disclosure, the control circuitry determines, based on the condition, one set from a plurality of sets of configuration value candidates for a parameter related to transmission of the second signal.

In the terminal according to the embodiment of the present disclosure, the plurality of sets includes a first set and a second set that is different from the first set.

In the terminal according to the embodiment of the present disclosure, the condition is a condition related to received quality for performing the repetition transmission of the first signal, and the control circuitry determines, based on a comparison of the received quality with a threshold value, whether to use the first set or the second set.

In the terminal according to the embodiment of the present disclosure, the condition is a condition related to a level of the repetition transmission of the first signal, and the control circuitry determines, based on the level, whether to use the first set or the second set.

In the terminal according to the embodiment of the present disclosure, the plurality of sets includes a first set and a second set that is calculated from the first set.

A base station according to an embodiment of the present disclosure includes: control circuitry, which, in operation, configures, based on a condition related to repetition transmission of a first signal, a transmission waveform of a second signal; and reception circuitry, which, in operation, receives the second signal based on the transmission waveform.

A communication method according to an embodiment of the present disclosure includes: configuring, by a terminal, based on a condition related to repetition transmission of a first signal, a transmission waveform of a second signal; and transmitting, by the terminal, the second signal using the transmission waveform.

A communication method according to an embodiment of the present disclosure includes: configuring, by a base station, based on a condition related to repetition transmission of a first signal, a transmission waveform of a second signal; and receiving, by the base station, the second signal based on the transmission waveform.

### INDUSTRIAL APPLICABILITY

An exemplary embodiment of the present disclosure is useful for radio communication systems.

### REFERENCE SIGNS LIST

100 Base station
101, 205 Controller
102, 206 Signal generator
103, 207 Transmitter
104, 201 Receiver
105, 202 Extractor
106, 203 Demodulator
107, 204 Decoder
200 Terminal

1. A terminal, comprising:
control circuitry, which, in operation, configures, based on a condition related to repetition transmission of a first signal, a transmission waveform of a second signal; and
transmission circuitry, which, in operation, transmits the second signal using the transmission waveform.

2. The terminal according to claim 1, wherein, the control circuitry configures the transmission waveform to be Discrete Fourier Transform-spread-Orthogonal Frequency Division Multiplexing (DFT-s-OFDM) when the repetition transmission of the first signal is performed.

3. The terminal according to claim 1, further comprising:
reception circuitry, which, in operation, receives configuration information related to the transmission waveform, wherein,
the control circuitry configures, when the repetition transmission of the first signal is performed, the transmission waveform to be Discrete Fourier Transform-spread-Orthogonal Frequency Division Multiplexing (DFT-s-OFDM) while ignoring the configuration information, and the control circuitry configures, when the repetition transmission of the first signal is not performed, the transmission waveform based on the configuration information.

4. The terminal according to claim 1, wherein,
the control circuitry determines the transmission waveform based on the condition related to at least one of a level of the repetition transmission of the first signal, a coverage enhancement level of the repetition transmission of the first signal, a number of repetition transmissions of the first signal, and/or received quality for performing the repetition transmission of the first signal.

5. The terminal according to claim 1, wherein, the control circuitry controls repetition transmission of the second signal based on the condition.

6. The terminal according to claim 5, wherein,
the condition is a condition related to received quality for performing the repetition transmission of the first signal, and
the control circuitry determines a request for the repetition transmission of the second signal in a case where the received quality is equal to or less than a threshold value.

7. The terminal according to claim 6, wherein, the control circuitry determines, regardless of the presence or absence of the repetition transmission of the first signal, when the request for the repetition transmission of the second signal is made, a number of repetition transmissions of the second signal based on one or some of bits of a Modulation and Coding Scheme (MCS) field included in assignment information for the second signal, and determines an MCS index based on a remaining bit of the MCS field.

8. The terminal according to claim 5, wherein, the control circuitry determines, based on the condition, one set from a plurality of sets of configuration value candidates for a parameter related to transmission of the second signal.

9. The terminal according to claim 8, wherein, the plurality of sets includes a first set and a second set that is different from the first set.

10. The terminal according to claim 9, wherein,
the condition is a condition related to received quality for performing the repetition transmission of the first signal, and
the control circuitry determines, based on a comparison of the received quality with a threshold value, whether to use the first set or the second set.

11. The terminal according to claim 9, wherein,
the condition is a condition related to a level of the repetition transmission of the first signal, and
the control circuitry determines, based on the level, whether to use the first set or the second set.

12. The terminal according to claim 8, wherein, the plurality of sets includes a first set and a second set that is calculated from the first set.

13. A base station, comprising:
control circuitry, which, in operation, configures, based on a condition related to repetition transmission of a first signal, a transmission waveform of a second signal; and
reception circuitry, which, in operation, receives the second signal based on the transmission waveform.

14. A communication method, comprising:
configuring, by a terminal, based on a condition related to repetition transmission of a first signal, a transmission waveform of a second signal; and
transmitting, by the terminal, the second signal using the transmission waveform.

15. A communication method, comprising:
configuring, by a base station, based on a condition related to repetition transmission of a first signal, a transmission waveform of a second signal; and
receiving, by the base station, the second signal based on the transmission waveform.
